(19) United States
(12) Patent Application Publication
(10) Pub. No.: US 2023/0281543 A1
(43) Pub. Date: Sep. 7, 2023

(54) SOFTWARE METHODS AND SYSTEMS FOR AUTOMATIC INNOVATION DETERMINATION AND USE

(71) Applicant: C Squared IP Holdings LLC, Scottsdale, AZ (US)

(72) Inventor: Kevin David HOWARD, Mesa, AZ (US)

(21) Appl. No.: 18/115,749

(22) Filed: Feb. 28, 2023

Related U.S. Application Data
(60) Provisional application No. 63/316,353, filed on Mar. 3, 2022.

(51) Int. Cl. G06Q 10/0637; G06F 8/41

(52) U.S. Cl. CPC G06Q 10/0637; G06F 8/433

(57) ABSTRACT

Methods and systems for automatic innovation determination and use are provided such that objective levels of innovation, efficiency, and complexity can be determined for a software system during the software design and construction process, allowing developers and management to understand and predict not only the contributions of individuals, or teams, but also the worth of those contributions. Further, metrics can be used to determine if two or more implementations of some product actually represent the same or closely linked solutions.

### CROSS-REFERENCE TO RELATED APPLICATIONS

The present application claims priority to and the benefit of U.S. Provisional Patent Application Ser. No. 63/316,353, filed Mar. 3, 2022, which is fully incorporated herein by reference.

### TECHNICAL FIELD

This disclosure relates generally to software systems and methods and, more particularly, to software systems and methods of objectively determining innovation, efficiency, and complexity levels during software design and construction processes.

### BACKGROUND

The concept of innovation is often attributed to new ways of doing things. For example, the ISO 56000:2020 standard defines innovation as “a new or changed entity realizing or redistributing value” where an entity can be a process, object, or organization. Invention is often used as a synonym for innovation. The United States Patent Act defines invention as “any new or useful process, machine, manufacture, composition of matter, or any new and useful improvement thereof.” Software implementations, especially those that are associated with patents, are frequently called “innovative,” but there is no objective measure of the innovation in general or software in particular.

This means that assertions of innovation go unquestioned and, without an objective comparison method, can cause confusion in the marketplace, such as is shown by conventional source-lines-of-code metrics, where tracking the number of lines of code sufficed to distinguish the work done by software generation teams. That is, the team that generated the most source lines of code per unit time was deemed the better team. No concept of the difficulty of the work performed or the efficiency of created work was used to evaluate individuals or teams, except anecdotally.

### SUMMARY OF THE INVENTION

The present invention provides methods and systems for automatic innovation determination and use, such that objective levels of innovation, efficiency, and complexity can be determined for a software system during the software design and construction process. These systems and methods allow developers and management to understand and predict not only the contributions of individuals, or teams, but also the worth of those contributions. Further, metrics can be used to determine if two or more implementations of some product actually represent the same or closely linked solutions.

### BRIEF DESCRIPTION OF THE DRAWINGS

FIG. 1 shows a flow chart of an example software system and method for automatic innovation determination and use, in accordance with embodiments of the present invention.

FIG. 1A shows an example of software as a series of functions, in accordance with embodiments of the present invention.

FIG. 2 shows an example of functional decomposition of software into a hierarchical tree of functions, in accordance with embodiments of the present invention.

FIG. 3 shows an example of the hierarchy of functions as threads connected using control conditions, in accordance with embodiments of the present invention.

FIG. 4 shows an example of connected functions combined into multiple pathways, in accordance with embodiments of the present invention.

FIG. 5 shows MPT HFD graphs depicting level one and level two functional decomposition, in accordance with embodiments of the present invention.

FIG. 6 shows an example diagram of pseudo code to component pathways, in accordance with embodiments of the present invention.

FIG. 7 shows an example diagram of flow chart to component pathways, in accordance with embodiments of the present invention.

FIG. 8 shows an example diagram of source code to component pathways, in accordance with embodiments of the present invention.

FIG. 9 shows an example diagram of connection between designers, high level design, detailed design, pathways, and source code, in accordance with embodiments of the present invention.

FIG. 10 shows an example diagram of transformation of a functional decomposition graph to a finite state machine, in accordance with embodiments of the present invention.

FIG. 11 shows an MPT hierarchical functional decomposition graph, LOAP, or functional aggregate pathway view, in accordance with embodiments of the present invention.

FIG. 12 shows an example diagram of linking two pathways, in accordance with embodiments of the present invention.

FIG. 13 shows an example diagram of one or more succeeding pathways linked to a single preceding pathway, in accordance with embodiments of the present invention.

FIG. 14 shows an example diagram of a LOAP with underlying aggregate pathways and associated code blocks, in accordance with embodiments of the present invention.

FIG. 15 shows an example diagram of design loop symbols to initial component pathway numbers, in accordance with embodiments of the present invention.

FIG. 16 shows an example of a single team time period innovation metric value average speed graph, in accordance with embodiments of the present invention.

FIG. 17 shows an example graph of average innovation metric value velocity for selected time span, in accordance with embodiments of the present invention.

FIG. 18 shows an example of a comparative average complete innovation metric velocity over time graph, in accordance with embodiments of the present invention.

FIG. 19 shows an example of a ranked complete innovation metric graph, in accordance with embodiments of the present invention.

FIG. 20 shows an example of an MPT hierarchical functional decomposition graph with schedule slip annotation, in accordance with embodiments of the present invention.

FIG. 21 shows an example of a Gantt chart, in accordance with embodiments of the present invention.

FIG. 22 shows an example graph of accumulated efficient innovation velocity (required source code vs. actual source code), in accordance with embodiments of the present invention.

FIG. 23 shows an example graph of accumulated efficient innovation metric average speed, in accordance with embodiments of the present invention.

FIG. 24 shows an example graph of accumulated efficient innovation average velocity, in accordance with embodiments of the present invention.

FIG. 25 shows an example of a Gantt chart with projected schedule slip feedback, in accordance with embodiments of the present invention.

FIG. 26 shows an example of a ranked accumulated average complete innovation metric values per product graph, in accordance with embodiments of the present invention.

FIG. 27 shows a Table 1 example of worker complexity-velocity profiles, in accordance with embodiments of the present invention.

FIG. 28 shows an example graph of accumulated efficient innovation prediction given worker allocation, in accordance with embodiments of the present invention.

FIG. 29 shows an example of reverse complexity sorted worker complexity-velocity profiles, in accordance with embodiments of the present invention.

FIG. 30 shows an example of a hiring complexity-velocity profile, in accordance with embodiments of the present invention.

FIG. 31 shows a Table 2 example of a training complexity-velocity profile, in accordance with embodiments of the present invention.

FIG. 32 shows a Table 3 example of a single worker comparative complexity-velocity profile, in accordance with embodiments of the present invention.

FIG. 33 shows a Table 4 example of average perturbation effects for a team, in accordance with embodiments of the present invention.

FIG. 34 shows an example graph of existing team on existing project with predicted schedule perturbation characterization, in accordance with embodiments of the present invention.

FIG. 35 shows an example graph of predicted team performance analysis, in accordance with embodiments of the present invention.

FIG. 36 shows an example diagram of component pathway connections using control conditions, in accordance with embodiments of the present invention.

FIG. 37 shows an example diagram of component pathway connections using control condition forming a loop, in accordance with embodiments of the present invention.

FIG. 38 shows a Table 5 example of an aggregative pathway control definition, in accordance with embodiments of the present invention.

FIG. 39 shows a Table 6 example depicting a first aggregate pathway, in accordance with embodiments of the present invention.

FIG. 40 shows a Table 7 example depicting a second aggregate pathway, in accordance with embodiments of the present invention.

FIG. 41 shows an example diagram of an irrelevant order component pathway family, in accordance with embodiments of the present invention.

FIG. 42 shows an example diagram of a family of pathways with different input and/or output precisions, in accordance with embodiments of the present invention.

FIG. 43 shows an example of a pathway family representation, in accordance with embodiments of the present invention.

FIG. 44 shows a Table 8 example depicting source code family, in accordance with embodiments of the present invention.

FIG. 45 shows an example diagram of electrical detailed design to component pathway, in accordance with embodiments of the present invention.

FIG. 46 shows an example diagram of detailed design elements for electrical and software conversion to component pathways, in accordance with embodiments of the present invention.

### DETAILED DESCRIPTION

Considering the social and economic impact attributed to innovation, especially with complex products like software applications, providing systems and methods of innovation measurement 100 would provide a powerful tool, allowing platform providers, investors, buyers, and sellers to objectively compare the level of innovation or “newness,” as well as the efficiency, number, and complexity of components needed to create the product and skill required to produce the product. If objective levels of innovation, efficiency, and complexity could be determined for a software system during the software design and construction process, it would allow developers and management to understand and predict not only the contributions of individuals, or teams, but also the worth of those contributions. If concepts like the running average speed, velocity, and acceleration of those contributions could be tracked in real time, better project management could occur.

The metrics of the systems and methods 100 of the present invention described herein can also be used to determine if two or more implementations of some product or service actually represent the same or closely linked solutions. It is possible to know that a software solution by one team is actually the result of that team using another team's solution and obscuring the fact by using different computer languages, different subroutine names, changing variable names, etc. It is also possible to know how much functionality was taken and the relative IP value of what was taken.

Various devices or computing systems can be included and adapted to process and carry out the aspects, computations, and algorithmic processing of the software systems and methods of the present invention. Computing systems and devices of the present invention may include a processor, which may include one or more microprocessors and/or one or more circuits, such as an application specific integrated circuit (ASIC), field-programmable gate arrays (FPGAs), etc. Further, the devices can include a network interface. The network interface is configured to enable communication with a communication network, other devices and systems, and servers, using a wired and/or wireless connection.

The devices or computing systems may include memory, such as non-transitive, which may include one or more non-volatile storage devices and/or one or more volatile storage devices (e.g., random access memory (RAM)). In instances where the computing devices include a microprocessor, computer readable program code may be stored in a computer readable medium or memory, such as, but not limited to drive media (e.g., a hard disk or SSD), optical media (e.g., an OVO), memory devices (e.g., random access memory, flash memory), etc. The computer program or software code can be stored on a tangible, or non-transitive, machine-readable medium or memory. In some embodiments, computer readable program code is configured such that when executed by a processor, the code causes the device to perform the steps described above and herein. In other embodiments, the device is configured to perform steps described herein without the need for code.

It will be recognized by one skilled in the art that these operations, algorithms, logic, method steps, routines, sub-routines, and modules may be implemented in software, in firmware, in special purpose digital logic, and any combination thereof without deviating from the spirit and scope of the present invention as recited within the claims attached hereto.

The devices or computing devices may include an input device. The input device is configured to receive an input from either a user (e.g., admin, user, etc.) or a hardware or software component—as disclosed herein in connection with the various user interface or automatic data inputs. Examples of an input device include a keyboard, mouse, microphone, touch screen and software enabling interaction with a touch screen, etc. The devices can also include an output device. Examples of output devices include monitors, televisions, mobile device screens, tablet screens, speakers, remote screens, etc. The output device can be configured to display images, media files, text, video, or play audio to a user through speaker output.

Server processing systems for use or connected with the systems of the present invention, can include one or more microprocessors, and/or one or more circuits, such as an application specific integrated circuit (ASIC), field-programmable gate arrays (FPGAs), etc. A network interface can be configured to enable communication with a communication network, using a wired and/or wireless connection, including communication with devices or computing devices disclosed herein. Memory can include one or more non-volatile storage devices and/or one or more volatile storage devices (e.g., random access memory (RAM)). In instances where the server system includes a microprocessor, computer readable program code may be stored in a computer readable medium, such as, but not limited to drive media (e.g., a hard disk or SSD), optical media (e.g., a DVD), memory devices, etc.

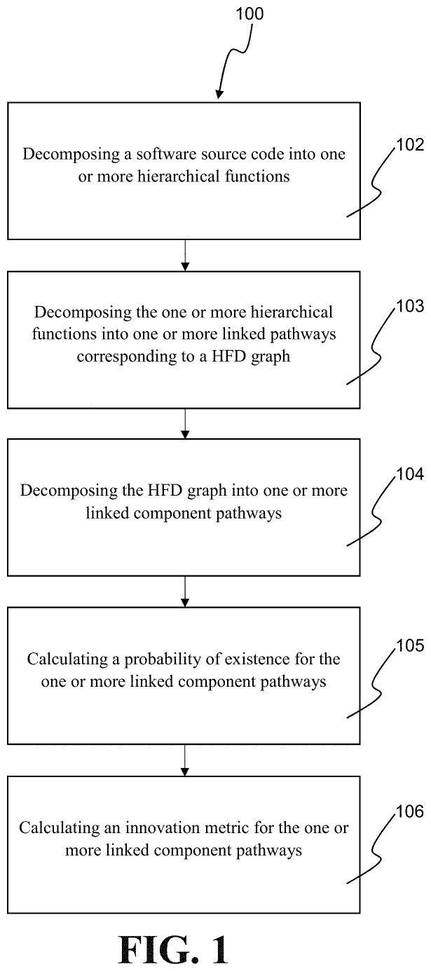

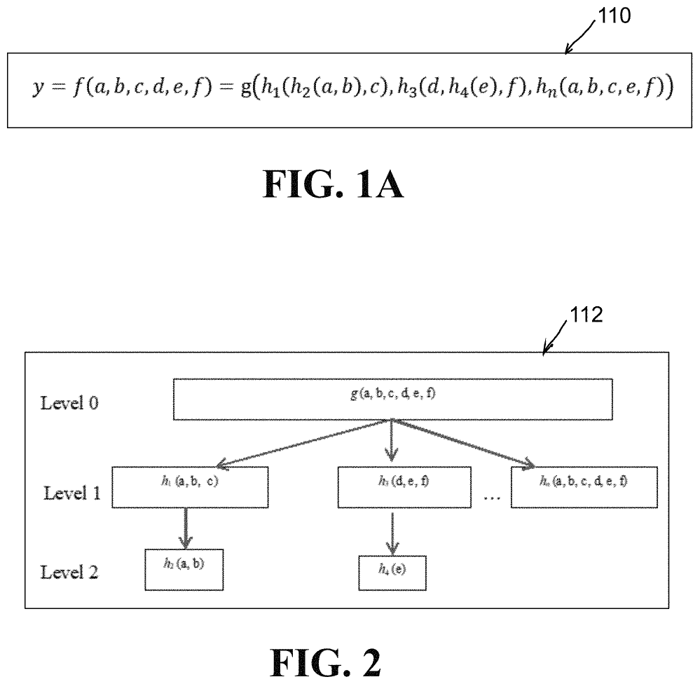

Referring to FIG. 1, with this and other concepts, systems, and methods of the present invention, software systems and methods 100 of automatic innovation determination comprise decomposing a software source code into one or more hierarchical functions (step 102), decomposing the one or more hierarchical functions into one or more linked pathways corresponding to a Hierarchical Functional Decomposition (HFD) graph (step 103), decomposing the HFD graph into one or more linked component pathways (step 104), calculating a probability of existence for the one or more linked component pathways (step 105); and calculating an innovation metric for the one or more linked component pathways (step 106).

In various embodiments, the systems and methods further comprises graphing innovation results of multiple of the one or more linked component pathways.

In various embodiments, the one or more linked component pathways comprise one or more Level One Aggregate Pathways (LOAPs).

In various embodiments, the one or more linked components pathways comprise one or more Functional Aggregate Pathways (FAPs).

In various embodiments, calculating an innovation metric comprises calculating a number of permutations possible for a specific number of the one or more linked component pathways selected at a time during a specific period of time.

In various embodiments, when the calculated probability of existence decreases, an innovation determination increases.

In various embodiments, the one or more hierarchical functions comprise one or more hierarchical function trees.

In various embodiments, the systems and methods further comprises converting one or more of the one or more hierarchical functions into one or more pseudo codes or one or more flow charts.

In various embodiments, the one or more pseudo codes or the one or more flow charts are transformed into source code.

In various embodiments, the systems and methods further comprises calculating a complexity of efficient innovation determination.

### Software Pathway Analysis

McCabe showed that all software systems can be analyzed as sets of linearly independent pathways whose complexity can be known. Further, such pathways can be hierarchical in nature.

Both McCabe and the systems and methods disclosed in U.S. Pat. No. 8,762,946, which is fully incorporated herein by reference, showed that a pathway comprises code blocks (blocks of assignment statements and/or subroutine calls) linked together by control statements and that looping structures can be thought of as control statements. As disclosed in U.S. Pat. No. 11,520,560, which is fully incorporated herein by reference, a pathway comprised of code blocks can be converted into time affecting linear pathways (TALPs). As such, the methods and systems disclosed herein can be applied to TALPs as well as pathways from MPT Hierarchical functional decomposition graphs.

The systems and methods disclosed in U.S. Pat. No. 8,959,494, which is fully incorporated herein by reference, taught that it is possible to take a software source code from an application and by using functional decomposition, automatically find the pathways of functions linked by their call order and/or by using control conditions.

In accordance with the present systems and methods 100, functions can be decomposed into a set of hierarchical functions (FIG. 1A). Further, functions can be decomposed and depicted as a tree of functions (FIG. 2). As such, FIG. 1A is an example of software as a series of functions 110 and FIG. 2 is an example of functional decomposition of software into a hierarchical tree of functions 112.

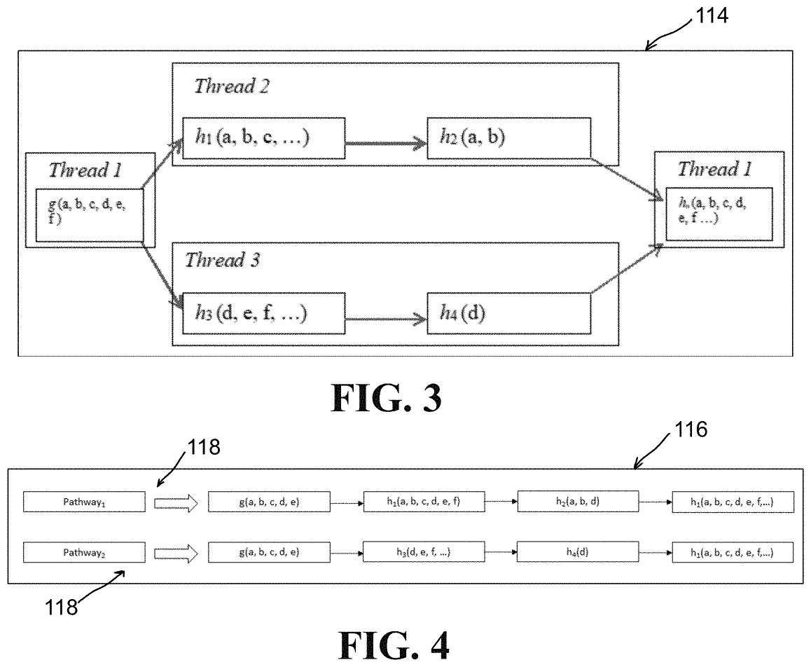

By using functional decomposition, the pathways of functions linked by their call order, and/or by using control conditions, can be automatically displayed in a hierarchical tree. These linked functions can be associated with threads of connected function execution and control conditions. FIG. 3 is an example of the hierarchy of functions as threads connected using control conditions 114.

FIG. 4 is an example of connected functions 116 combined into multiple pathways 118. Each of the connected functions in the threads can be shown as a set of pathways in which one or more pathways of one function are connected to one or more pathways of another function.

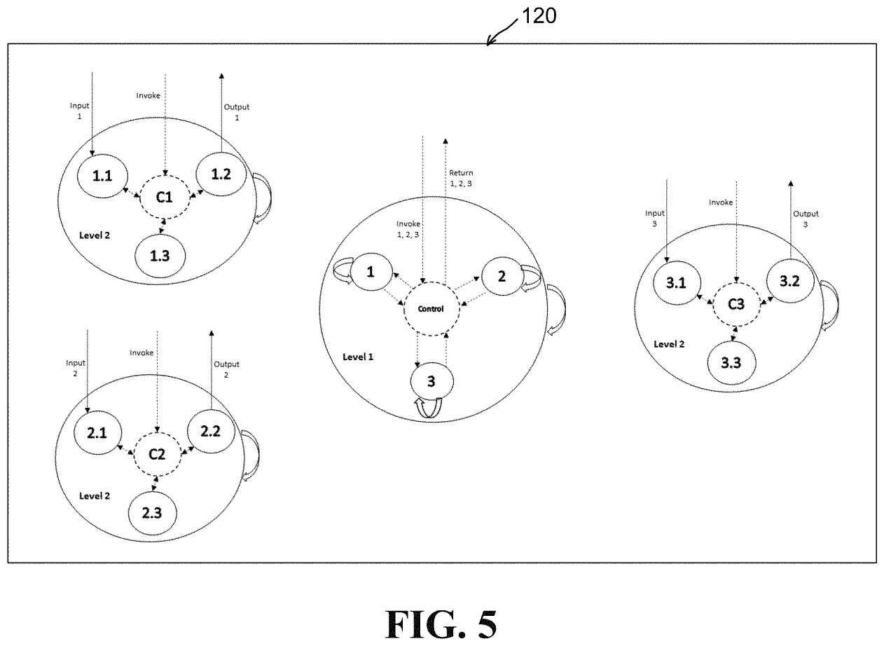

FIG. 5 shows 5 MPT HFD graphs 120 depicting level one and level two functional decomposition. The set of pathways created by connecting functions, that are themselves not within a function, represents the highest level of pathways, level one aggregate pathways (LOAPs), and corresponds to the level one functional decomposition of a Massively Parallel Technologies, Inc., (MPT) Hierarchical Functional Decomposition graph (MPT HFD). Decomposing functions further gives successively lower level graphs combined with conversion of these connected functions into threads of function execution with control conditions that can be depicted as connected functions called function aggregate pathways (FAPs) within the currently decomposed function.

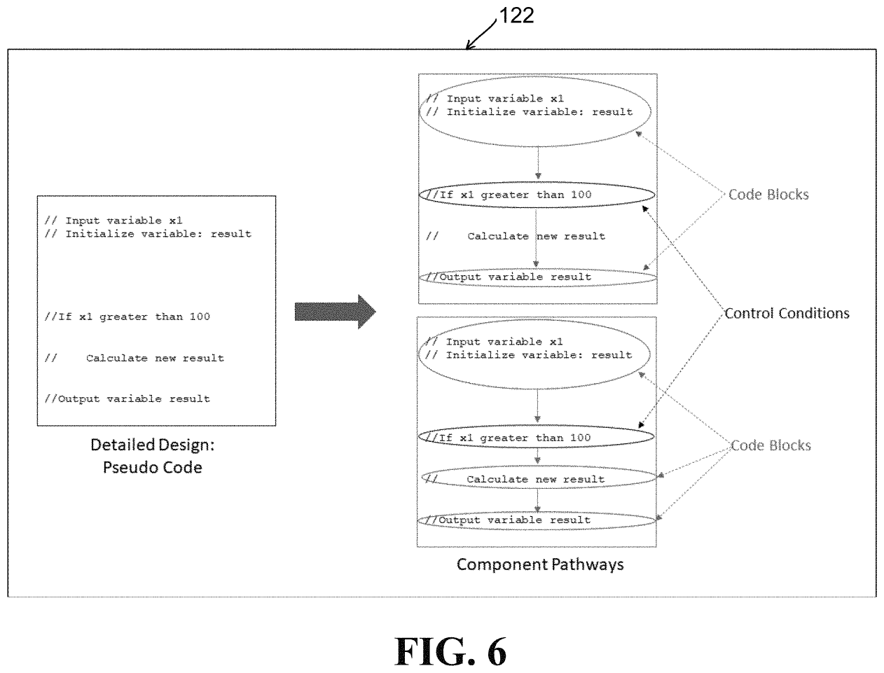

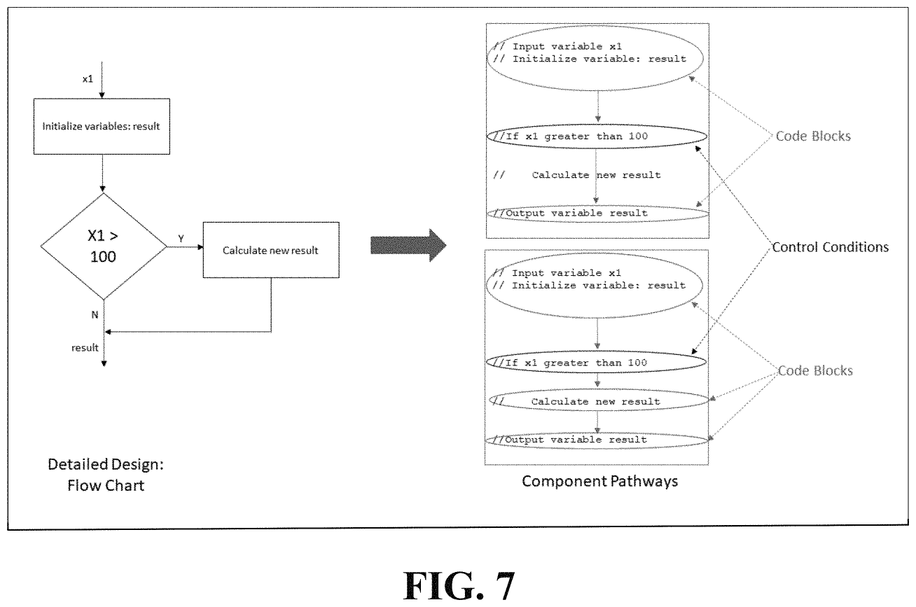

There is at least one functional decomposition level that has no additional functions for which decomposition is possible and represents the end of functional decomposition. In MPT HFD, decomposition graphs at any level are considered part of high-level design. Like all functions in a high-level design, those that do not further decompose can be represented by detailed design, that is, either pseudo code or flow charts. Like application source code, pseudo code identifies not just pathways of connected functions but also blocks of code that perform data transformations connected with control conditions, which are herein called component pathways. An example 122 of pseudo code to component pathways is shown in FIG. 6. An example of a flowchart 124 is shown in FIG. 7 for an end of functional decomposition level (flow chart to component pathways).

As discussed above, at any level of high-level design, functions can also be converted into a detailed design, that is, pseudo code or flow charts, which can be depicted as component pathways comprising code blocks connected using control conditions. Pseudo code and flow charts can also be transformed into source code. Thus, there is a connection between MPT HFD graphs, level one aggregate pathways, function aggregate pathways, detailed design, component pathways, and source code. This connection is bidirectional, meaning it is possible to start with an MPT HFD and end with source code or start with source code and end with an MPT HFD graph.

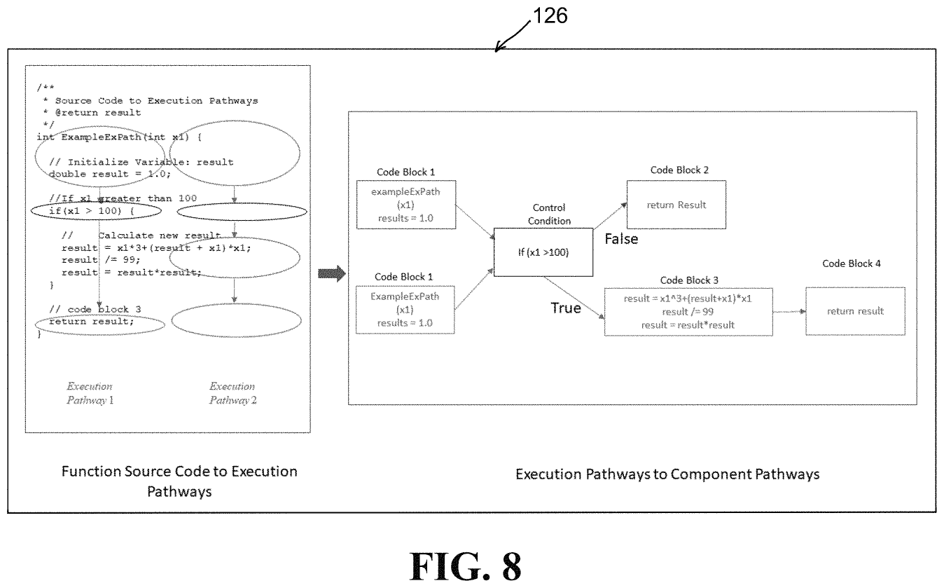

A key aspect of this bidirectionality is the conversion of function source code into component pathways and the conversion of component pathways back into source code. Each function that is written as source code contains one or more execution pathways. An execution pathway is simply the processing path taken within the source code given some input dataset. Since each execution pathway is comprised of linked code blocks and control conditions and since, as shown in FIG. 7, component pathways are also comprised of code blocks and control conditions, it is possible to transform one into the other. FIG. 8 is an example 126 of source code to component pathways.

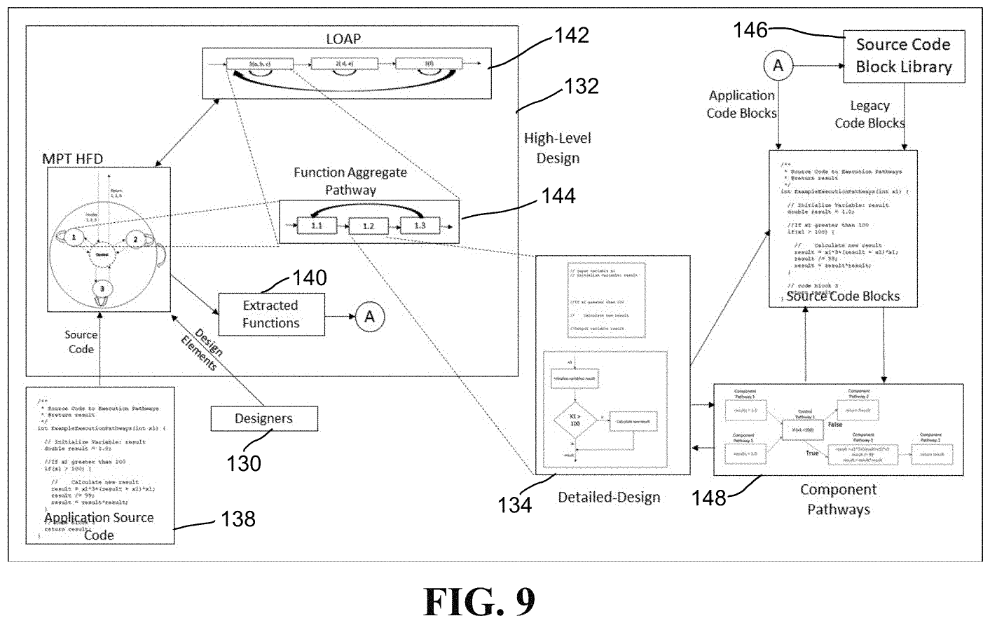

FIG. 9 shows a connection between designers 130, high-level design 132, detailed design 134, pathways, and source code 138, showing the process flow required to convert application source code into an MPT HFD graph, either generated automatically from legacy code or directly created by one or more system designers 130. Once the graph is created, it is used to automatically extract function source code 140, if available, level one aggregate pathways (LOAPs) 142, and function aggregate pathways (FAPs) 144. Since LOAPs 142 and FAPs 144 can be viewed as linked component pathways, they represent data transformations at the level at which they occur. The designers 130 can then generate detailed designs 134 (pseudo code or flow charts) which are automatically associated with the functions of LOAPs 142 and FAPs 144. If the source of the high-level design 132 was application source code, then the detailed design elements are automatically associated with the extracted code blocks, which are saved in a source code block library 146. Detailed design elements are automatically converted into component pathways 148 and associated to their respective code blocks from the source code block library 146, if they exist; otherwise, source code must be written for the detailed design elements.

A function can be said to be fully written when there is source code for all component pathways within that function. Higher level functions can be said to be fully written when there is source code for every function in every function aggregate pathway within that higher level function. A LOAP 142 can be said to be fully written when every function of every function aggregate pathway within the LOAP 142 has source code. Finally, a software application can be said to be fully written when there is source code for every function of every LOAP 142 within the software application.

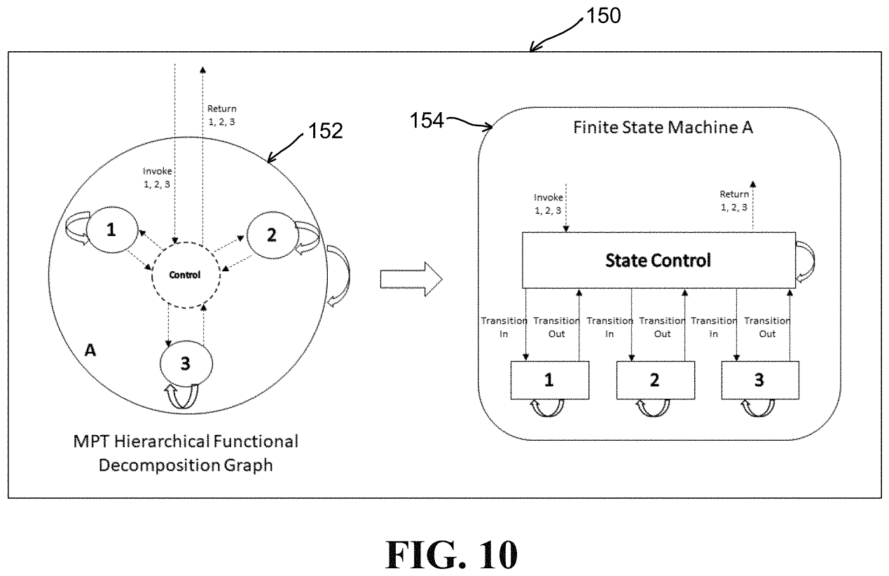

FIG. 10 is an example 150 of transformation of functional decomposition graph 152 to finite state machine 154. If the control conditions associated with functional decomposition include looping structures, then the functional decomposition diagram 152 is equivalent to a finite state machine state transition diagram 154.

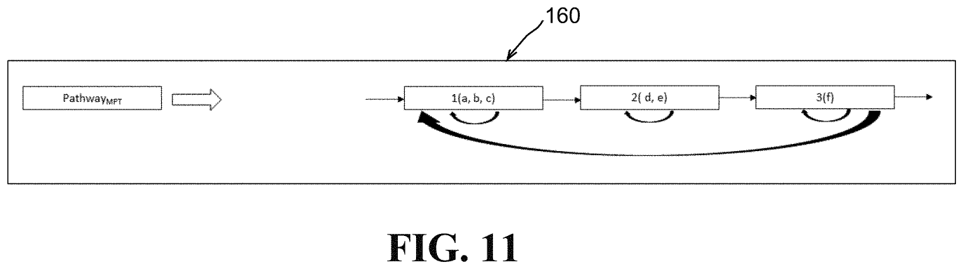

FIG. 11 shows a MPT Hierarchical Functional Decomposition graph 160, with a LOAP or FAP view. Unlike conventional functional decomposition diagrams, the MPT Hierarchical Functional Decomposition graph 160 includes control and loops and, therefore, is equivalent to a finite state machine. This changes how a pathway is displayed.

Note that each loop can represent a separate linearly independent pathway. Since an MPT Hierarchical Functional Decomposition graph 160 is equivalent to a finite state machine and since a functional decomposition graph can be viewed as LOAPs and FAPs, functions in LOAPs and FAPs linked using control conditions that include loops and the LOAPS and FAPs themselves are equivalent to finite state machines. This is important because finite state machines can be used not only to describe software systems but also electrical systems, mechanical systems, electro-mechanical systems, and more. Therefore, the innovation metric described herein can be used in several markets or technology areas as long as it is applied to finite state machine-based products in general, or to MPT Hierarchical Functional Decomposition graph representations in particular.

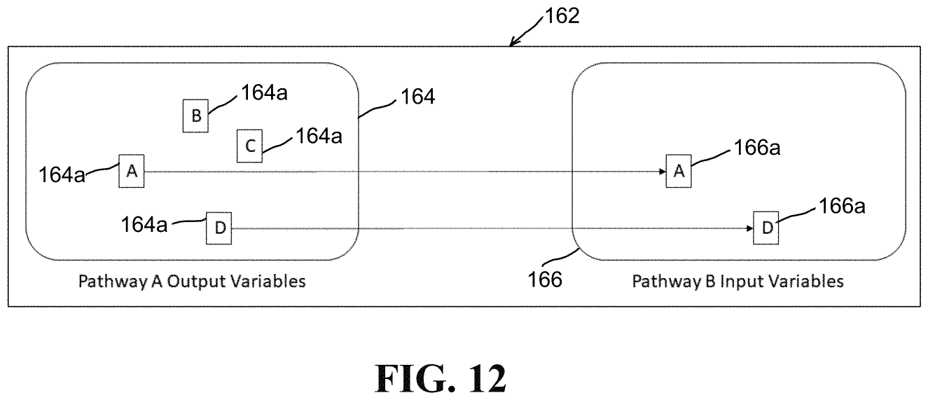

FIG. 12 is an example 162 of linking two pathways. At the component pathway level, to link together pathways, the output of a preceding pathway 164 must have variable attributes that are fully compatible with the input attributes of the succeeding pathway 166. Fully compatible means only that all succeeding pathway variables 166a have a corresponding preceding output variable 164a.

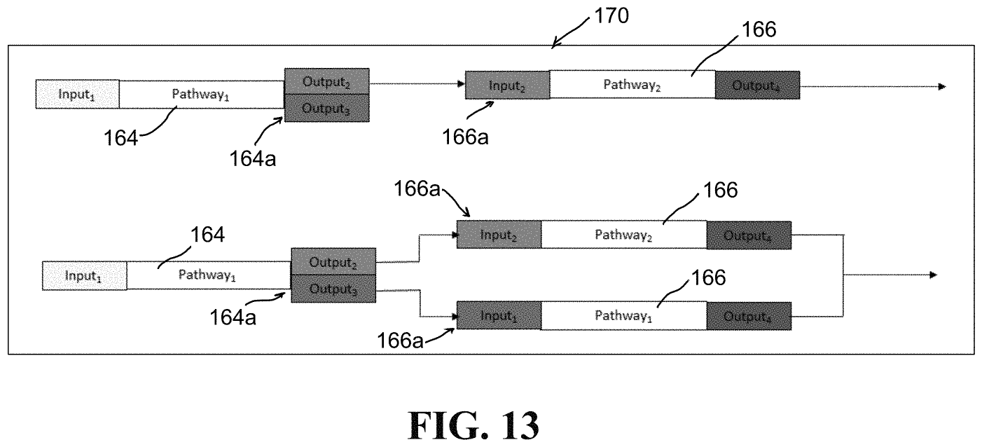

FIG. 13 is an example 170 showing one or more succeeding pathways linked to a single preceding pathway. Note that there can be more preceding output variables 164a than required by the succeeding input variables 166a for the pathways to be able to link. The opposite is not true: there cannot be more required succeeding input variables 166a than there are compatible preceding output values 164a. Because there can be more preceding pathway output variables 164a than can be consumed by some succeeding pathway 166, it is possible to activate multiple succeeding pathways 166 from a single preceding pathway 164.

Consider that a LOAP 142 comprises functions, each of which can have an associated detailed design. Since the detailed design of each LOAP function can be transformed into one or more component pathways and since the LOAP functions connect to one another if they are in the same LOAP 142, then component pathways of the connected LOAP functions are linked. Regardless of the level of decomposition, any linked functions in high-level design are also represented as linked component pathways.

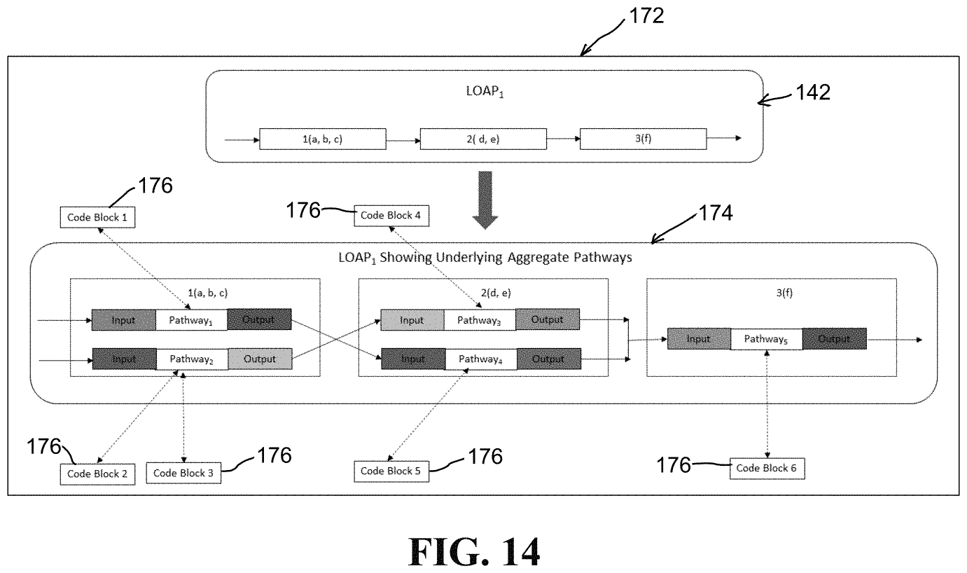

FIG. 14 is an example 172 of a LOAP 142 with underlying aggregate pathways 174 and associate code blocks 176. The set of linked component pathways of the linked functions of a LOAP is called an aggregate pathway. Every LOAP comprises one or more aggregate pathways. A function aggregate pathway is an aggregate pathway at the function level. Linked function aggregate pathways form an aggregate pathway, and if every function aggregate pathway is viewed as component pathways, those component pathways linked together form an aggregate pathway. The set of linked component pathways of linked functions at the function aggregate pathway level is called a function pathway. Every function aggregate pathway comprises one or more function pathways.

Given some set of component pathways, each representing a subset of a complete required data transformation, it is possible to link together some or all pathways in the set by using the output of a preceding pathway with the input of a succeeding pathway. The probability of selecting the correct component pathways linked together in the correct order to form an aggregate pathway can then be calculated.

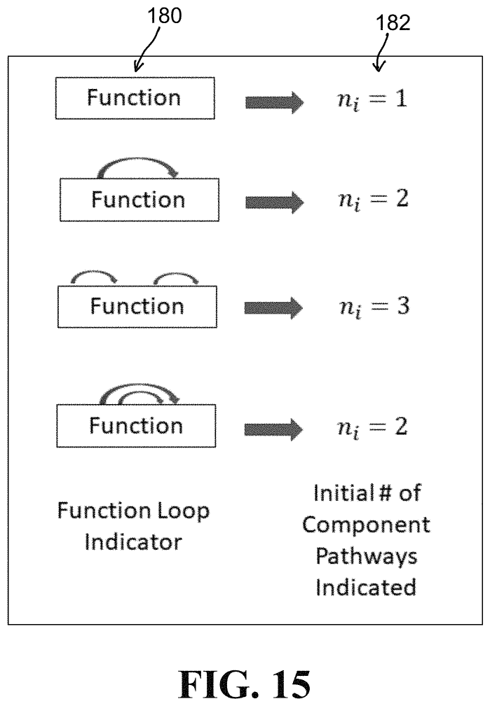

FIG. 15 shows design loop symbols 180 to initial component pathway numbers 182. It is possible to automatically analyze a designer-created MPT HFD graph or some original source code to obtain the total number of component pathways in an application. If a function defined in an MPT HFD graph does not have an associated detailed design, then the number of associated component pathways is initialized to one plus the number of independent loops shown for the function.

When a detailed design is attached, the actual number of component pathways is used in place of the initial value. Using this data, the number of permutations possible and the probability of randomly selecting a set of component pathways in the correct order can be determined.

The total number of component pathways in a software application is specified by “nᵢ.” If additional component pathways are added or removed, then the value of “nᵢ” automatically changes to reflect that. The number of component pathways that are selected at a time during a specific time period from an application for use is considered “aᵢ,” where “i” represents a particular application. That number of component pathways selected at a time during a specific time period with source code associated with the code blocks and control conditions of each component pathway is represented by “aᵢ*” where the asterisk indicates that there is attached source code. As additional source code is associated with additional linked pathways then the value of “aᵢ*” increases.

It is now possible to construct an innovation metric for design using design, pathway, and source code information. We start constructing an innovation metric by calculating the number of permutations possible for a specific number of component pathways selected at a time during a specific period of time from all possible component pathways in a software application with no repetition as:

$$Permutations for Selecting a Subset of \qquad Equation 1$$

$$Component Pathways in an Application with No Repetition$$

$$P ( {n}_{i} , {a}_{i} ) = \frac{{n}_{i} !}{( {n}_{i} - {a}_{i} ) !}$$

Where nᵢ=# of component pathways in the i^{th} application
αᵢ=# of component pathways selected at a time in the i^{th} application

This changes to the following for the number of component pathways with attached source code selected at a time:

$$Permutations for Selecting a Subset of \qquad Equation 2$$

$$Component Pathways with Attached Source Code$$

$$P ( {n}_{i} , {a}_{i}^{*} ) = \frac{{n}_{i} !}{( {n}_{i} - {a}_{i}^{*} ) !}$$

It should be noted that “aᵢ*” can always be substituted for “aᵢ” in any of the following equations.

Since the number of selected component pathways “aᵢ” is always less than or equal to the total number of component pathways in the application, “nᵢ-aᵢ” is always greater than or equal to zero. Since 0!=1, the permutations always exist.

The probability of selecting the given number of component pathways in the correct order from all possible pathways in a software application is given as:

$$Probability of Selecting a Given Number of \qquad Equation 3$$

$$Pathways in the Correct Order$$

$$probability ( {n}_{i} , {a}_{i} ) = \frac{1}{P ( {n}_{i} , {a}_{i} )} = \frac{( {n}_{i} - {a}_{i} ) !}{{n}_{i} !}$$

The innovation metric is defined using the number of component pathways selected at a time during a specific time period in the correct order for the application as the inverse of the probability of randomly selecting the correct pathways in the correct order, that is, the number of permutations. As the probability decreases, innovation increases.

Because the number of permutations can be a very large number, it is better to take the log of the number of permutations as the metric rather than the permutation value itself. Since the log (1)=0, using the log of the permutation allows for there to be no innovation.

$$Innovation Metric \qquad Equation 4$$

$$I ( i ) = log ( P ( {n}_{i} , {a}_{i} ) ) = log ( \frac{{n}_{i} !}{( {n}_{i} - {a}_{i} ) !} )$$

If “aᵢ*” has been substituted for “aᵢ” then I*(i) becomes I*(i). The functions E(i) and C(i) behave analogously.

Given that a software application comprises one or more aggregate pathways and that the aggregate pathways represent separate lines of data transformation as linked component pathways, it is possible to treat each aggregate pathway as a separate application, with “nᵢ” and “aᵢ” adjusted accordingly in the innovation metric. The relative innovation then between two aggregate pathways that are constructed using a common set of component pathways can be given as the ratio of two innovation metrics, I (1) and I (2).

$$Relative Innovation of Two Aggregate Pathways \qquad Equation 5$$

$${I}_{R} = \frac{I ( 1 )}{I ( 2 )} ; if fI ( 2 ) > 0$$

Two aggregate pathways, Agg (1) and Agg (2), can be said to be equivalent if they have the same aggregate pathway data transformations, T_{I(1)} and T_{I(2)}, and the relative innovation I_{R} equals one.

Agg(1)=Agg(2); if I_{R}=1 and T_{I(}1)=T1(2) Equation 6: Equivalent Aggregate Pathways

Two aggregate pathways can be considered approximately equivalent if they have equal or equivalent aggregate pathway data transformations and/or the difference between the aggregate pathway data transformations is less than or equal to some epsilon.

Agg(1)≈Agg(2); if |T_{I(1)}−T_{I(2)}|≤ε Equation 7: Approximately Equivalent Aggregate Pathways

where ε is small and their data transformations are equivalent

Given two aggregate pathways, the first is considered more innovative than the second if the relative innovation, I_{R}, is greater than one.

Agg(1) more innovative than Agg(2); if I_{R}<1 Equation 8: First Aggregate Pathway More Innovative than the Second Aggregate Pathway

Given two aggregate pathways, the second is considered more innovative than the first if I_{R} is less than one.

Agg(2) more innovative than Agg(1); if I_{R}<1 Equation 9: Second Aggregate Pathway More Innovative than the First Aggregate Pathway

Two aggregate pathways, Agg (1) and Agg (2), that have the same aggregate pathway data transformations, T_{I (1)} and T_{I (2)}, but whose relative innovation is not equal to one can be interchanged. Since an aggregate pathway with lower innovation implies it has fewer linked component pathways which implies less source code then it should be interchanged with all instances of aggregate pathways with the same transformation and higher innovation. This ensures that the more efficient aggregate pathway is always used to obtain some transformation. All of this means that generating innovation alone is not a sufficient goal. Instead, the goal should be to generate just enough innovation needed to achieve some data transformation.

In making the determination that one aggregate pathway is “better” than another, additional factors must be considered. As the number of selected component pathways increases, efficiency might decrease since increasing the number of component pathways can mean increasing the number of functions unnecessarily used or increasing duplication of effects. This would be analogous to the way a source-lines-of-code metric gives precedence to inefficient software. Dividing the innovation metric by the number of component pathways will help give a less biased metric. Thus, efficient innovation can be defined as the innovation metric divided by the number of selected pathways.

$$Efficient Innovation Metric \qquad Equation 10$$

$$E ( i ) = log ( \frac{{n}_{i} !}{\frac{( {n}_{i} - {a}_{i} ) !}{{a}_{i}}} ) = log ( \frac{{n}_{i} !}{{a}_{i} ( {n}_{i} - {a}_{i} ) !} )$$

The complexity of efficient innovation also must be considered to adequately compare two aggregate pathways or the achievement of the individuals, teams or organizations that generated the innovation. A team generating twice the amount of innovation that is half as complex as another team isn't as impressive as a team generating the same amount of innovation that is twice as complex. U.S. Pat. No. 9,335,974, which is fully incorporated herein by reference, shows that McCabe's cyclomatic complexity, the measure of the complexity of software, can be generated using a MPT HFD graph. The cyclomatic complexity of aggregate pathways can be generated and associated with efficient innovation with the resulting metric showing how to measure the amount of innovation, its efficiency, and its complexity.

$$Complete Innovation Metric \qquad Equation 11$$

$$C ( i ) = γ E ( i ) = γlog ( \frac{{n}_{i} !}{{a}_{i} ( {n}_{i} - {a}_{i} ) !} ) ;$$

where: γ=cyclomatic complexity

Two aggregate pathways (treated as applications), Agg (1) and Agg (2), that generate the same transformations and are constructed using pathways from the same set of component pathways can now be compared using the Complete Innovation Metric.

$$Relative Complete Innovation Metric of \qquad Equation 12$$

$$Two Aggregate Pathways$$

$${C}_{R} = \frac{C ( 1 )}{C ( 2 )} ; if fC ( 2 ) > 0$$

Two aggregate pathways are equal in complete innovation if the Relative Complete Innovation metric equals one.

Agg(1) has same complete innovation as Agg(2); if f C_{R}=1 Equation 13: Equal Complete Innovation of Two Aggregate Pathways

The first aggregate pathway has greater complete innovation than the second aggregate pathway if the relative Complete Innovation metric is greater than one.

Agg(1) has greater complete innovation than Agg(2); if f C_{R}>1 Equation 14: First Aggregate Pathway Has Greater Complete Innovation than Second Aggregate Pathway

The second aggregate pathway has greater complete innovation than the first aggregate pathway if the relative Complete Innovation metric is less than one.

Agg(2) has greater complete innovation than Agg(1); if f C_{R}<1 Equation 15: Second Aggregate Pathway Has Greater Complete Innovation than First Aggregate Pathway

### Using Innovation Metric Change Over Time Graphs

The performance of organizations, teams, products, and workers can now be compared using the innovation metrics, and innovation generated per organization, team, product, or worker can be tracked. This is accomplished using “a_{i,organization (j)},” “a_{i team (j)},” “a_{i product (j)},” and “a_{i worker (j)}” instead of “aᵢ” to represent the selected number of component pathways in the “i^{th}” application that was completed by the “j^{th}” organization, team, product or worker.

As detailed previously herein, it is possible to substitute “aᵢ*” for “aᵢ” when analyzing component pathways with associated source code.

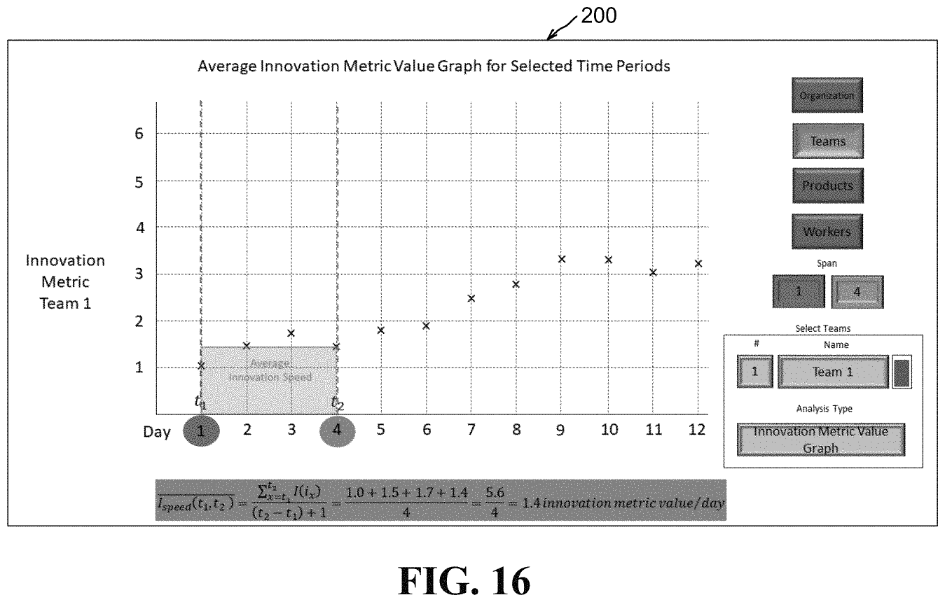

Using either the innovation, efficient innovation, or complete innovation metric identified for each of multiple specific equal periods of time from the start of each time period “t₁” to the end of that time period “t₂” for a particular organization, team, product or worker, the average innovation (or efficient or complete innovation) metric speed, or rate of change in the innovation metric, can be calculated.

$$Average Innovation Metric Speed \qquad Equation 16$$

$$\overline{{I}_{Speed} ( {t}_{1} , {t}_{2} )} = \frac{{\sum }_{x = {t}_{1}}^{{t}_{2}}}{( {t}_{2} - {t}_{1} ) + 1} = \frac{{\sum }_{x = {t}_{1}}^{{t}_{2}} log ( \frac{{n}_{{t}_{1}} !}{( {n}_{{t}_{1}} - {a}_{x} ) !} )}{( {t}_{2} - {t}_{1} ) + 1}$$

where nₜ_{₁}=number of component pathways for application at time t₁, αₓ=selected number of component pathways for application during time period x FIG. 16 is an example of a single team time period innovation metric value average speed graph 200.

$$Average Efficient Innovation Metric Speed \qquad Equation 17$$

$$\overline{{E}_{Speed} ( {t}_{1} , {t}_{2} )} = \frac{{\sum }_{x = {t}_{1}}^{{t}_{2}} E ( {i}_{x} )}{( {t}_{2} - {t}_{1} ) + 1}$$

$$Average Complete Innovation Metric Speed \qquad Equation 18$$

$$\overline{{C}_{Speed} ( {t}_{1} , {t}_{2} )} = \frac{{\sum }_{x = {t}_{1}}^{{t}_{2}} C ( {i}_{x} )}{( {t}_{2} - {t}_{1} ) + 1}$$

The average innovation metric velocity is the rate of innovation metric value change along a vector from some starting time to some ending time.

$$Average Innovation Metric Velocity \qquad Equation 19$$

$$\overline{{I}_{Velocity} ( {t}_{1} , {t}_{2} )} = \frac{\overline{I ( {t}_{2} )} - \overline{I ( {t}_{1} )}}{( {t}_{2} - {t}_{1} ) + 1}$$

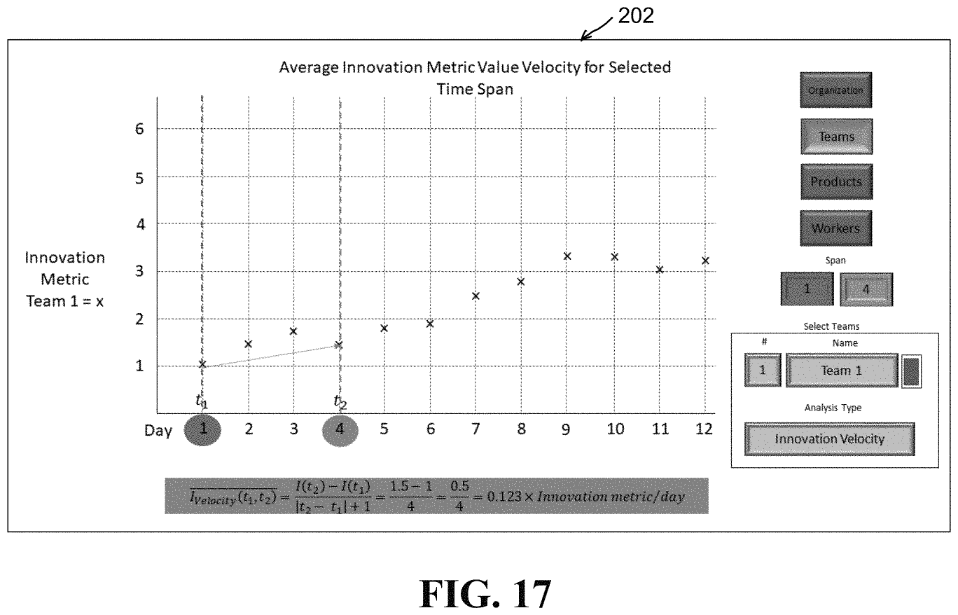

FIG. 17 is an example 202 of average innovation metric value velocity for selected time span.

$$Average Efficient Innovation Metric Velocity \qquad Equation 20$$

$$\overline{{E}_{Velocity} ( {t}_{1} , {t}_{2} )} = \frac{\overline{{E}_{Speed} ( {t}_{2} )} - \overline{{E}_{Speed} ( {t}_{1} )}}{( {t}_{2} - {t}_{1} ) + 1}$$

$$Average Complete Innovation Metric Velocity \qquad Equation 21$$

$$\overline{{C}_{Velocity} ( {t}_{1} , {t}_{2} )} = \frac{\overline{{C}_{Speed} ( {t}_{2} )} - \overline{{C}_{Speed} ( {t}_{1} )}}{( {t}_{2} - {t}_{1} ) + 1} ;$$

The average innovation metric acceleration is the change in velocity between some starting and ending time period.

$$Average Innovation Metric Value Acceleration \qquad Equation 22$$

$$\overline{{I}_{Acceleration} ( {t}_{1} , {t}_{2} )} = \frac{\overline{{I}_{Velocity} ( {t}_{2} )} - \overline{{I}_{Velocity} ( {t}_{1} )}}{( {t}_{2} - {t}_{1} ) + 1}$$

$$Average Efficient Innovation Metric Acceleration \qquad Equation 23$$

$$\overline{{E}_{Acceleration} ( {t}_{1} , {t}_{2} )} = \frac{\overline{{E}_{Velocity} ( {t}_{2} )} - \overline{{E}_{Velocity} ( {t}_{1} )}}{( {t}_{2} - {t}_{1} ) + 1}$$

$$Average Complete Innovation Metric Acceleration \qquad Equation 24$$

$$\overline{{C}_{Acceleration} ( {t}_{1} , {t}_{2} )} = \frac{\overline{{C}_{Velocity} ( {t}_{2} )} - \overline{{C}_{Velocity} ( {t}_{1} )}}{( {t}_{2} - {t}_{1} ) + 1}$$

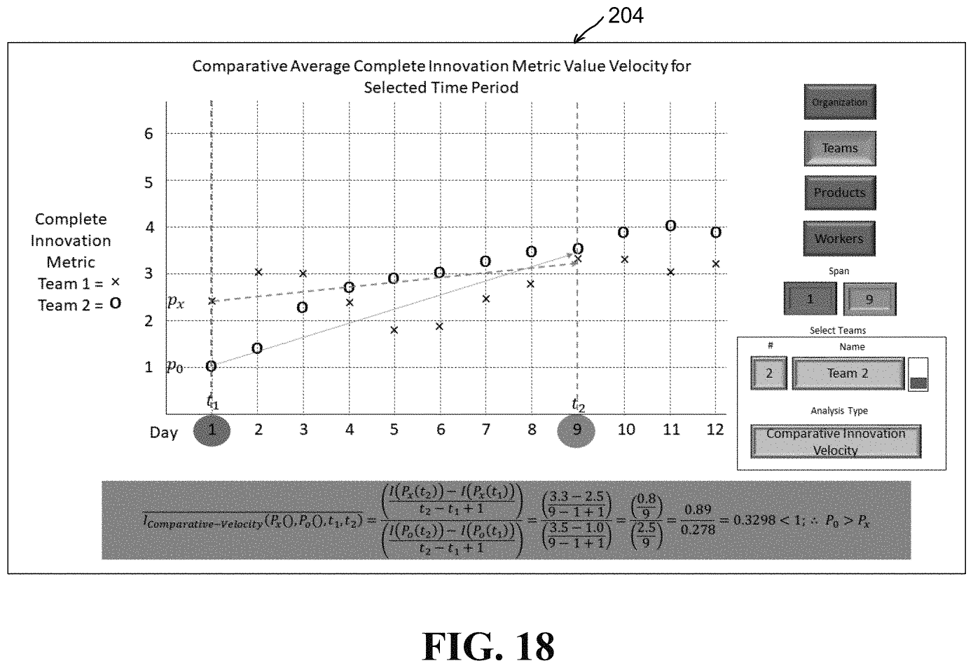

FIG. 18 is an example of a comparative average complete innovation metric velocity over time graph 204. It is possible to compare the speed, velocity, and acceleration metrics of multiple organizations, teams, products, or workers by overlaying the data in a comparison graph.

There are many types of “innovation metrics over time” graphs possible, though they are constrained to two general categories: average innovation metric values over time and comparative average innovation metrics over time. Average innovation metric values over time graphs allow the innovation for a single organization, team, product, or worker to be analyzed over some time span. This analysis allows the system, or visually, an operator, to determine performance trends.

The comparative average innovation metrics over time graphs 204 allow the innovation from multiple organizations, teams, products, or workers to be analyzed and compared over some time span, allowing the system, or an operator, to compare the relative performance of multiple organizations, teams, or workers.
1) Average Innovation Metric Speed,
2) Average Innovation Metric Velocity,
3) Average Innovation Metric Acceleration,
4) Average Efficient Innovation Metric Speed,
5) Average Efficient Innovation Metric Velocity,
6) Average Efficient Innovation Metric Acceleration,
7) Average Complete Innovation Metric Speed,
8) Average Complete Innovation Metric Velocity,
9) Average Complete Innovation Metric Acceleration,
10) Comparative Average Innovation Metric Speed,
11) Comparative Average Innovation Metric Velocity,
12) Comparative Average Innovation Metric Acceleration,
13) Comparative Average Efficient Innovation Metric Speed,
14) Comparative Average Efficient Innovation Metric Velocity,
15) Comparative Average Efficient Innovation Metric Acceleration,
16) Comparative Average Complete Innovation Metric Speed,
17) Comparative Average Complete Innovation Metric Velocity, and/or
18) Comparative Average Complete Innovation Metric Acceleration.

It is also possible to have combination graphs called ranked average innovation graphs, which show the relative innovation metric generation of organizations, teams, products, and workers.
1) Ranked Average Innovation Metric Values of Workers in Products,
2) Ranked Average Innovation Metric Values of Workers on Teams,
3) Ranked Average Innovation Metric Values of Workers in Organizations,
4) Ranked Average Efficient Innovation Metric Values of Workers in Products,
5) Ranked Average Efficient Innovation Matric Values of Workers on Teams,
6) Ranked Average Efficient Innovation Matric Values of Workers in Organizations,
7) Ranked Average Complete Innovation Metric Values of Workers in Products,
8) Ranked Average Complete Innovation Metric Values of Worker on Teams,
9) Ranked Average Complete Innovation Metric Values of Workers in Organizations,
10) Ranked Average Innovation Metric Values of Products on Teams,
11) Ranked Average Innovation Metric Values of Products in Organizations,
12) Ranked Average Efficient Innovation Metric Values of Products on Teams,
13) Ranked Average Efficient Innovation Metric Values of Products in Organizations,
14) Ranked Average Complete Innovation Metric Values of Products on Teams,
15) Ranked Average Complete Innovation Metric Values of Products in Organizations,
16) Ranked Average Innovation Metric Values of Teams in Organizations,
17) Ranked Average Efficient Innovation Metric Values of Teams in Organizations, and/or
18) Ranked Average Complete Innovation Metric Values of Teams in Organization

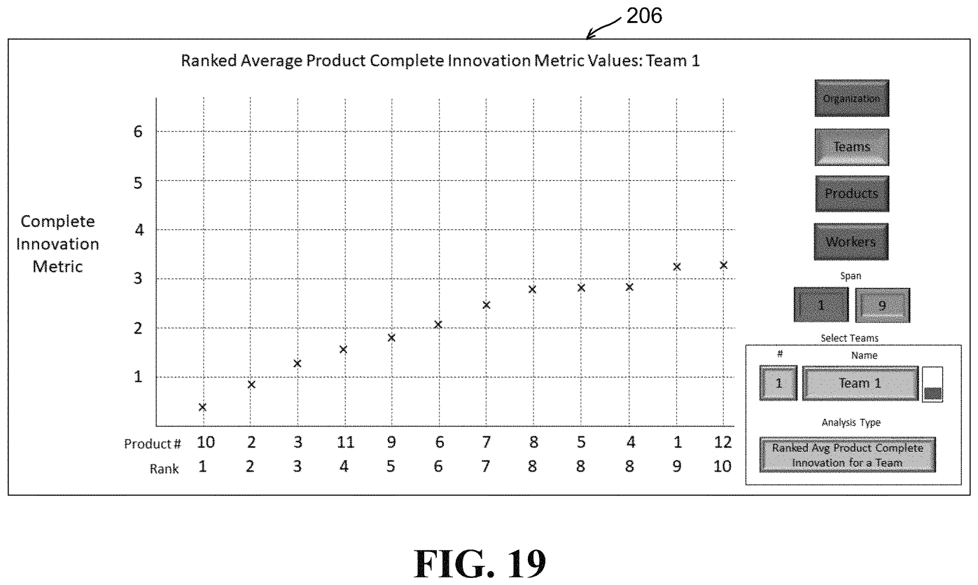

FIG. 19 is an example of a ranked complete innovation metric graph 206.

Schedule Prediction from Accumulated Innovation Metrics

The system and methods of U.S. Pat. No. 9,292,263, which is fully incorporated herein by reference, showed that MPT Hierarchical Functional Decomposition (MPT HFD) graphs can tie into Gantt or PERT charts via functions. Detailed design from functional decomposition associates design functions with component pathways, which in turn can be associated with source code. As detailed above, the number of component pathways that have associated source code is indicated by “aᵢ*” when calculating innovation metric values. These values can be used to determine the rate at which functions are being associated with detailed design and source code.

A function is considered complete when all of its component pathways have been associated with source code. By tracking the rate at which source code is associated with component pathways, the rate of function completion can be tracked and compared with the expected rates from the Gantt chart to predict schedule slips. By using innovation metrics for tracking and prediction instead of a count of completed functions or source lines of code, design innovation, efficiency, and complexity are also measured and at a level more detailed than functions alone, and more complete than source lines of code.

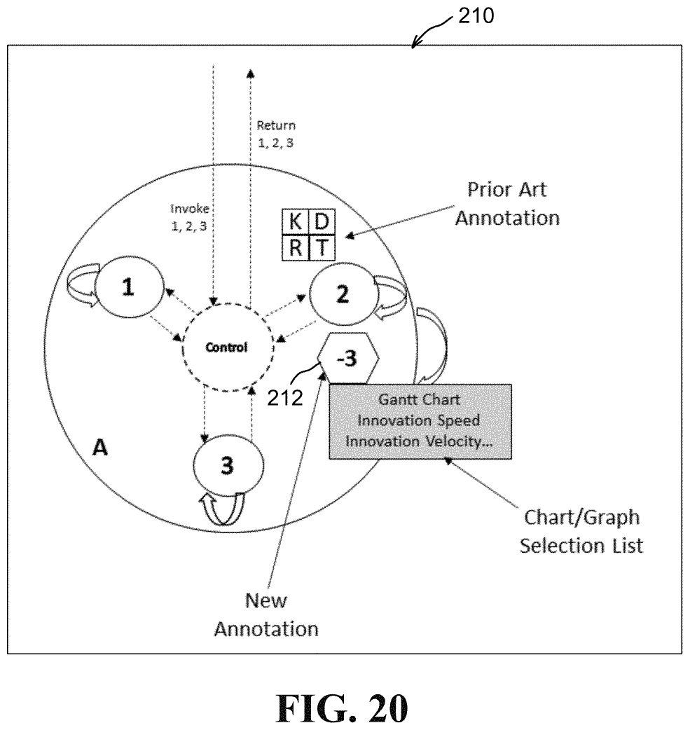

FIG. 20 is an example of a MPT hierarchical functional decomposition graph 210 with schedule slip annotation 212. The MPT HFD can include an annotation that shows when a particular function has pathways expected to slip, shown as a negative number, or expected to be ahead of schedule, shown as a positive number.

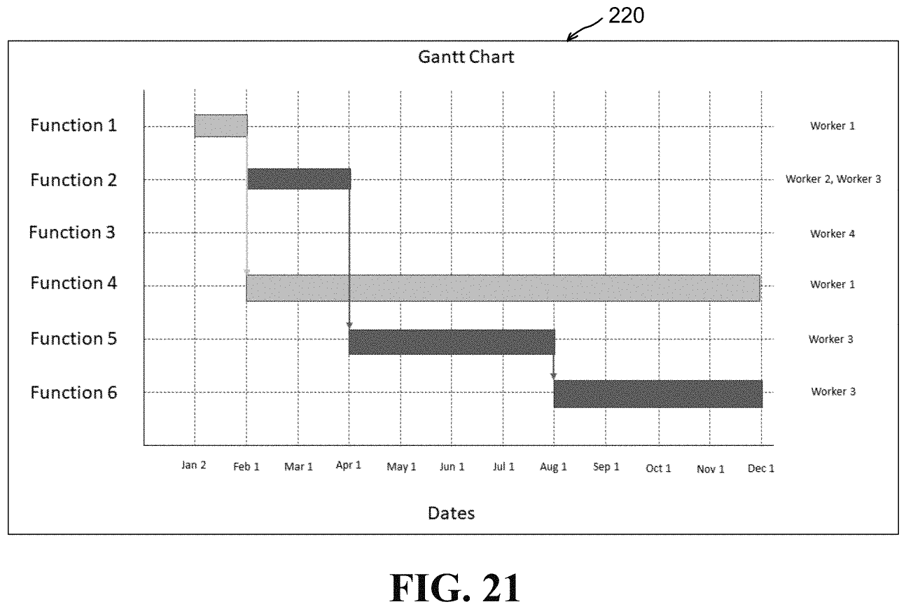

Selecting the new annotation causes the associated Gantt, or alternatively PERT, chart and graph options to be displayed. FIG. 21 is an example Gantt chart 220.

Typically, software coding assignments are performed on a function-by-function basis. These functions are then tracked using Gantt or PERT charts, which link together functions to be written by the programmers assigned to write the code, and an estimate of when the work will be complete. Given a high-level design, programmers typically produce detailed design and source code for each function assigned to them. The detailed design allows the system to generate component pathways. These component pathways are associated with source code, either created by the programmers or found by the system. Using the starting and completion dates of each function in a Gantt chart (e.g., chart 220), the system of the present invention automatically identifies the number of required days for each function.

Equations that are analogous to those created for specific time period innovation, efficient innovation, and complete innovation metrics can be used to create accumulated innovation, efficient innovation, and complete innovation metrics. The number of component pathways associated with source code that are completed is tracked on an ongoing basis, along with the innovation metrics based on an accumulated number of selected component pathways from the start to a point in time. As long as the tracked component pathways are associated with the functions in the Gantt chart, completion rates for each function can be calculated using innovation metrics based on the accumulated number of selected component pathways.

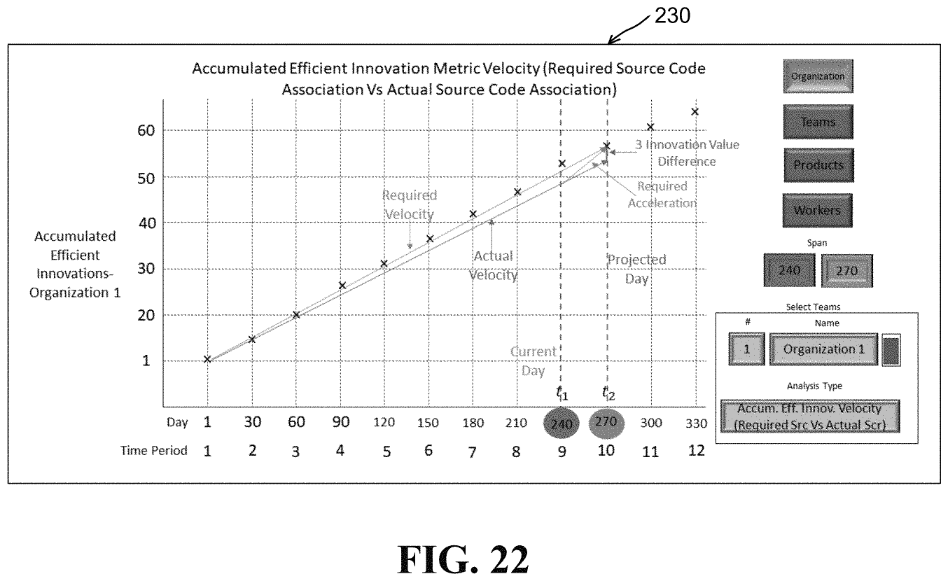

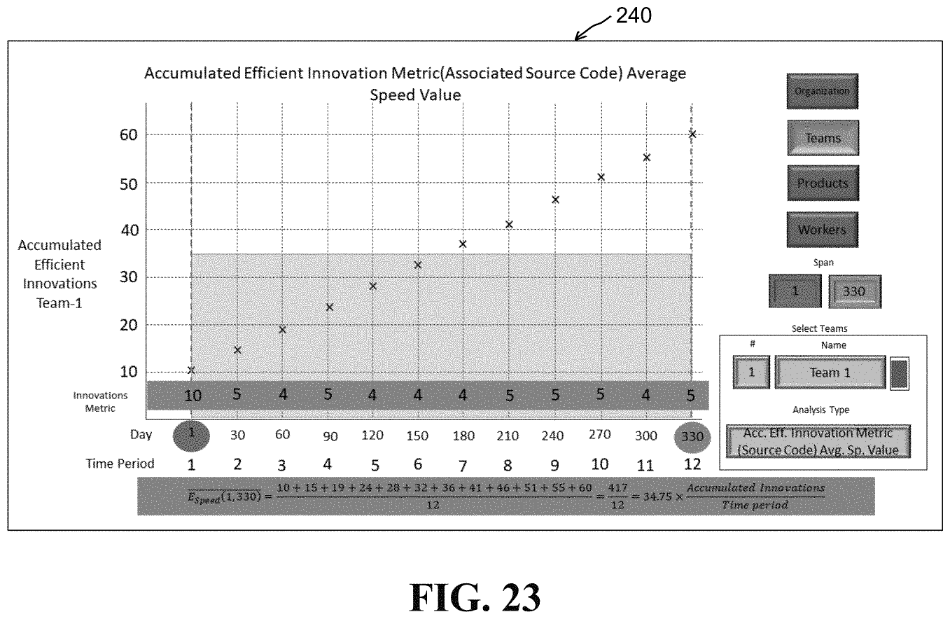

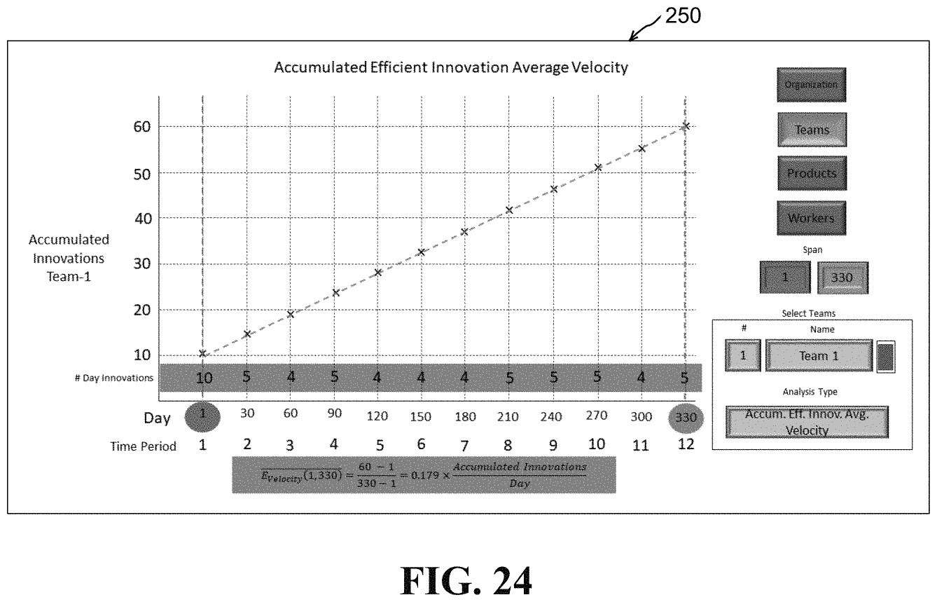

As detailed herein, functional decomposition to lower levels changes the number of component pathways in the software application. This is especially true for a designer-created detailed designs. Because the number of component pathways changes as more of the design is completed, it is possible to track design progress using innovation metrics. Detailed design that does not yet have an associated source code can have source code added at a later date, which means it is also possible to track the progress of code completion, or the completion of a function, as source code is written and associated with the function's component pathways using innovation metrics. FIG. 22 is an example 230 of accumulated efficient innovation velocity (required source code vs. actual source code). FIG. 23 is an example 240 of accumulated efficient innovation metric average speed. FIG. 24 is an example 250 of accumulated efficient innovation average velocity.

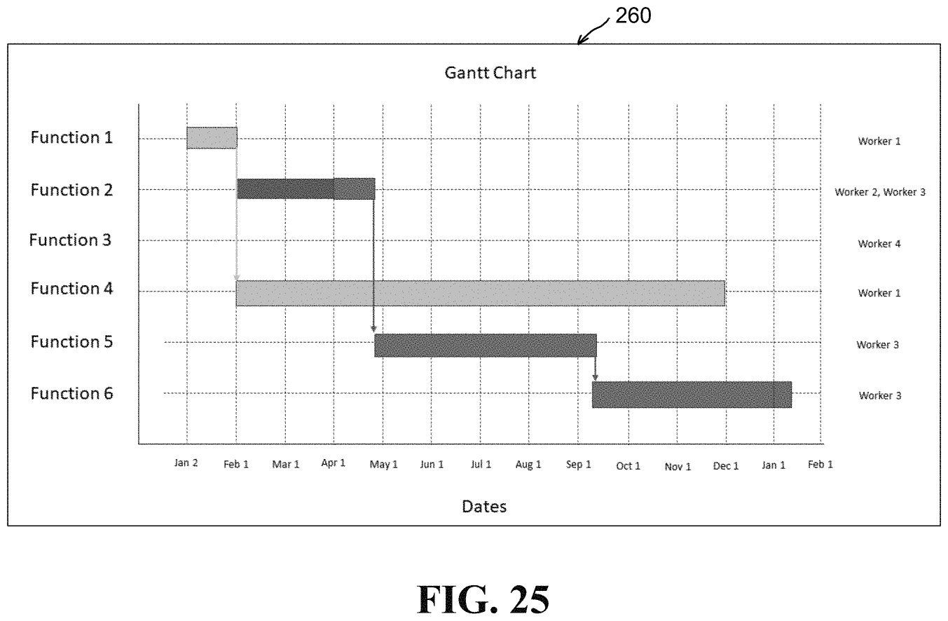

Since the accumulated innovation over time graphs allow for innovations that are associated with functions to be tracked and completion times for the function projected, the data from these graphs can be used to automatically change Gantt chart entries. FIG. 25 is an example of a Gantt chart 260 with projected schedule slip feedback.

It is noted that accumulated innovation over time graphs can be automatically generated for an entire organization, teams within an organization, products created by teams, and individual workers. Several accumulated innovations over time graphs are possible:
1) Accumulated Innovation Metric Speed,
2) Accumulated Innovation Metric Velocity,
3) Accumulated Innovation Metric Acceleration,
4) Accumulated Efficient Innovation Metric Speed,
5) Accumulated Efficient Innovation Metric Velocity,
6) Accumulated Efficient Innovation Metric Acceleration,
7) Accumulated Complete Innovation Metric Speed,
8) Accumulated Complete Innovation Metric Velocity,
9) Accumulated Complete Innovation Metric Acceleration,
10) Comparative Accumulated Innovation Metric Speed,
11) Comparative Accumulated Innovation Metric Velocity,
12) Comparative Accumulated Innovation Metric Acceleration,
13) Comparative Accumulated Efficient Innovation Metric Speed,
14) Comparative Accumulated Efficient Innovation Metric Velocity,
15) Comparative Accumulated Efficient Innovation Metric Acceleration,
16) Comparative Accumulated Complete Innovation Metric Speed,
17) Comparative Accumulated Complete Innovation Metric Velocity, and/or
18) Comparative Accumulated Complete Innovation Metric Acceleration

It is also possible to have combined accumulated graphs called ranked accumulated average innovation graphs:
1) Ranked Accumulated Average Innovation Metric Values of Workers in Products,
2) Ranked Accumulated Average Innovation Metric Values of Workers on Teams,
3) Ranked Accumulated Average Innovation Metric Values of Workers in Organizations,
4) Ranked Accumulated Average Efficient Innovation Metric Values of Workers in Products,
5) Ranked Accumulated Average Efficient Innovation Matric Values of Workers on Teams,
6) Ranked Accumulated Average Efficient Innovation Matric Values of Workers in Organizations,
7) Ranked Accumulated Average Complete Innovation Metric Values of Workers in Products,
8) Ranked Accumulated Average Complete Innovation Metric Values of Worker on Teams,
9) Ranked Accumulated Average Complete Innovation Metric Values of Workers in Organizations,
10) Ranked Accumulated Average Innovation Metric Values of Products on Teams,
11) Ranked Accumulated Average Innovation Metric Values of Products in Organizations,
12) Ranked Accumulated Average Efficient Innovation Metric Values of Products on Teams,
13) Ranked Accumulated Average Efficient Innovation Metric Values of Products in Organizations,
14) Ranked Accumulated Average Complete Innovation Metric Values of Products on

Teams,
15) Ranked Accumulated Average Complete Innovation Metric Values of Products in Organizations,
16) Ranked Accumulated Average Innovation Metric Values of Teams in Organizations,
17) Ranked Accumulated Average Efficient Innovation Metric Values of Teams in Organizations, and/or
18) Ranked Accumulated Average Complete Innovation Metric Values of Teams in Organization

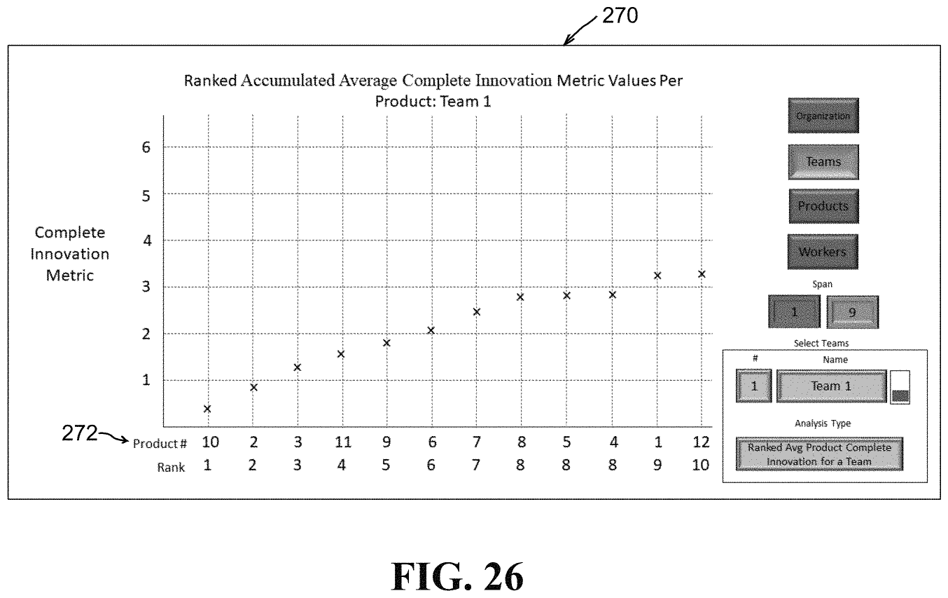

FIG. 26 is an example of a ranked accumulated average complete innovation metric values per product graph 270.

The ranked graphs can be used to compare organizations, teams, products, and workers. For example, FIG. 26 is used to compare the innovation of various products 272 created by Team 1. The data generated by ranking can also be used by the system of the present invention to automatically select organizations, teams, products, and workers based upon their ranking.

Worker Analytics from Innovation Metrics

A Gantt chart that is associated with an MPT HFD has associated workers, as shown in FIG. 21 and FIG. 25. The progress made in completing component pathways in functions on a Gantt chart can be tracked per worker to predict schedule progress as a function of the workers assigned to the work prior to any actual work being performed.

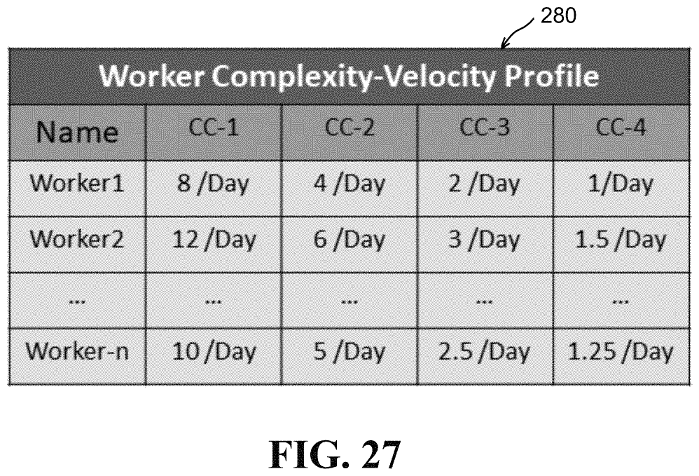

Progress per worker can be tracked as a function of the complexity of the work. A table of the accumulated efficient innovation metric average velocity tracked per worker and the associated cyclomatic complexity values is created by averaging the velocities of all detected efficient innovation metrics of a particular cyclomatic complexity value. This is shown in FIG. 27—Error! Reference source not found., an example of worker complexity velocity profile 280.

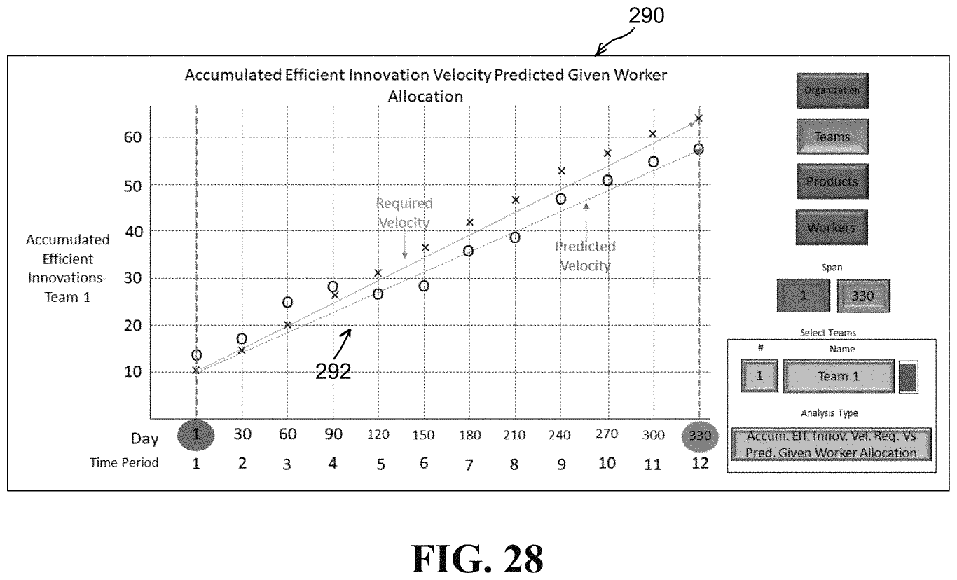

Once the worker complexity-velocity profile tables 280 have been created, it is possible to more accurately predict the completion times. This prediction can be added to the Accumulated Efficient Innovation graph (e.g., FIG. 28—example of accumulated efficient innovation prediction given worker allocation), giving the Accumulated Efficient Innovation

Prediction Given Worker Allocation graph 290.

Using this method, the present system can more accurately predict both schedule shortages and overages on the same graph. Since the Worker Complexity-Velocity Profile can be used for predictive purposes, it can also be used to automatically allocate the best workers to use from an available set of workers.

Because complete innovation metrics associated with component pathways measures innovation, efficiency, and complexity, the complete innovation metric velocity of each worker can be compared against the complete innovation metric velocity 292 required for every component pathway in a software application. Any worker whose complete innovation metric velocity, given some cyclomatic complexity level for a needed set of component pathways, equals or exceeds what is required by the Gantt chart-indicated time frame for those functions with the same cyclomatic complexity level, would be able to meet or exceed the time frame imposed by that Gantt chart. If there are no such workers, then the worker who comes closest should be selected.

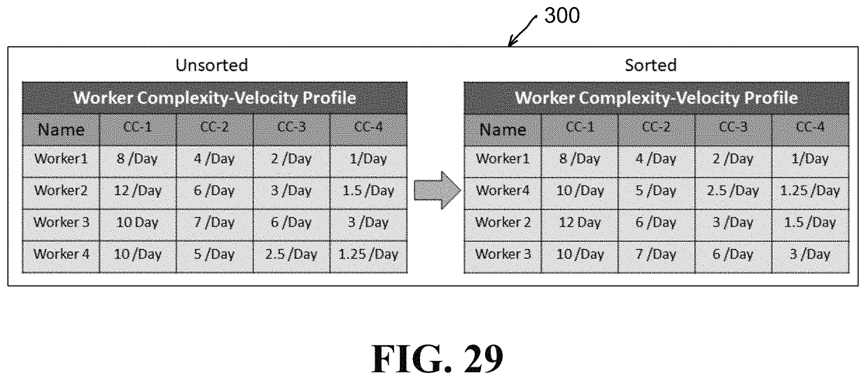

Because it is typically more difficult to find workers who excel at creating more complex codes, such workers should be saved for more complex work. A list of available workers can be sorted with those who perform better at higher complexity levels at the bottom. Then the first worker that can meet the completion velocity requirements should be the one who is selected. FIG. 29 is an example 300 of reverse complexity sorted worker complexity-velocity profiles.

Automatic worker allocation allows the system to automatically predict schedule shortfalls based on Worker Complexity-Velocity Profiles. If all workers have been allocated and there is unallocated work, additional workers who meet the profiles needed for the complexity of the remaining work need to be hired. Given that the component pathways associated with the functions requiring source code have associated cyclomatic complexity, then not only the number of workers needed for the remaining work, but also the skill level required by those workers, can be automatically generated by the system.

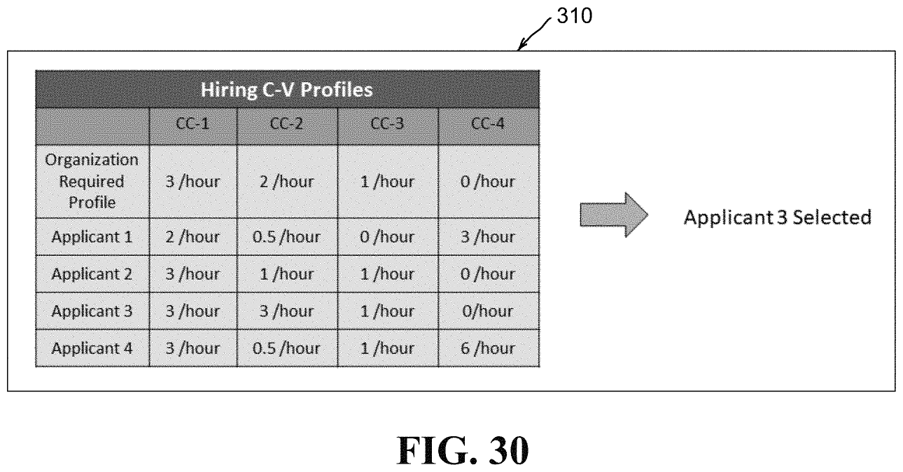

FIG. 30 is an example 310 of hiring complexity-velocity profiles. Given some set of MPT

HFD designs at different cyclomatic complexity levels, it is possible calculate the worker complexity-velocity profile of each applicant in pre-hiring testing. Workers can then be matched to an organization's complexity and performance requirements, allowing the applicant who best meets the organization's needs to be automatically selected.

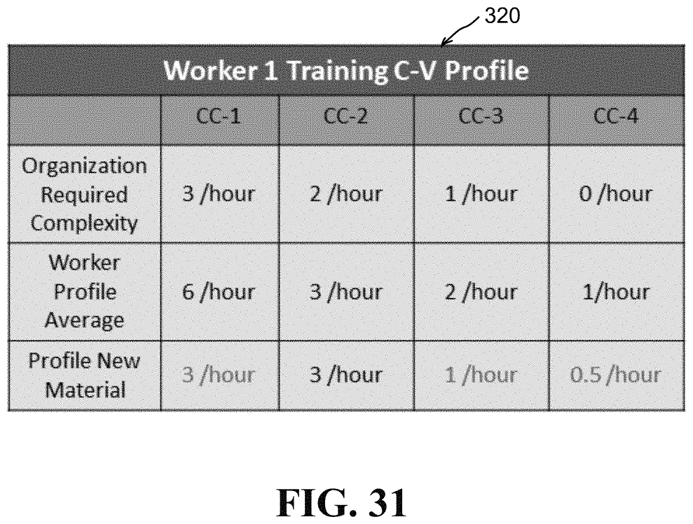

Once workers are hired, training materials for continuous worker improvement can be associated with a set of component pathways that are associated with cyclomatic complexity, allowing the organization to understand the length of training time needed by each worker. FIG. 31 provides Table 2—an example of a training complexity-velocity profile 320.

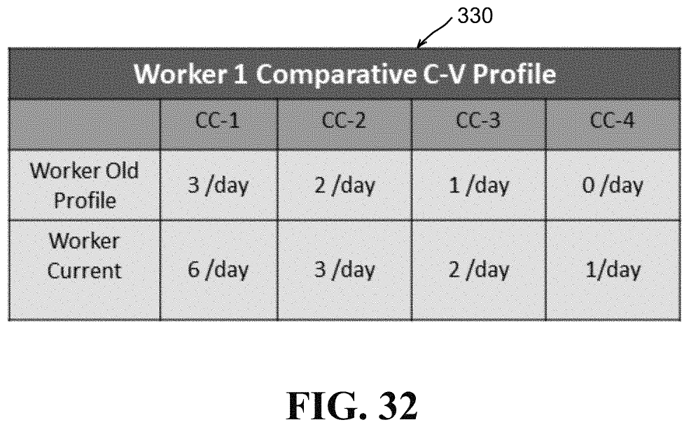

FIG. 32 provides Table 3—an example of a single worker comparative complexity-velocity profile 330. Improvement can be shown in a worker comparative complexity-velocity table that shows progress in work performance for work at various complexity levels for a single worker.

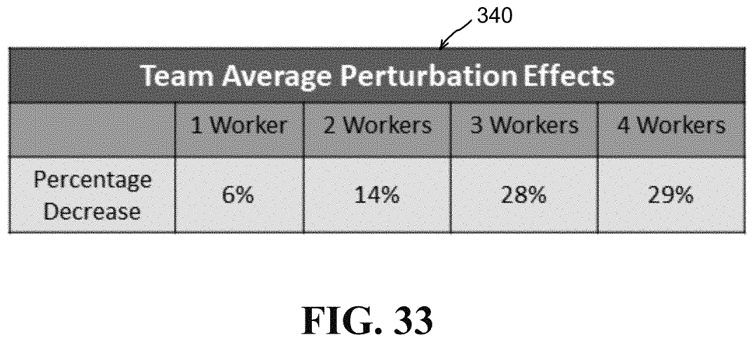

Adding workers to a team in the middle of a project can increase schedule slips. This effect is different for different teams. Since there is an average accumulated innovation metric velocity computed for the team as a whole as well as for the individual workers, the immediate impact on the team due to a productivity slowdown from adding a new team member is calculated as negative velocity, the percentage of velocity decrease, for the team and is tracked. FIG. 33 provides Table 4—an example 340 of average perturbation effects for a team.

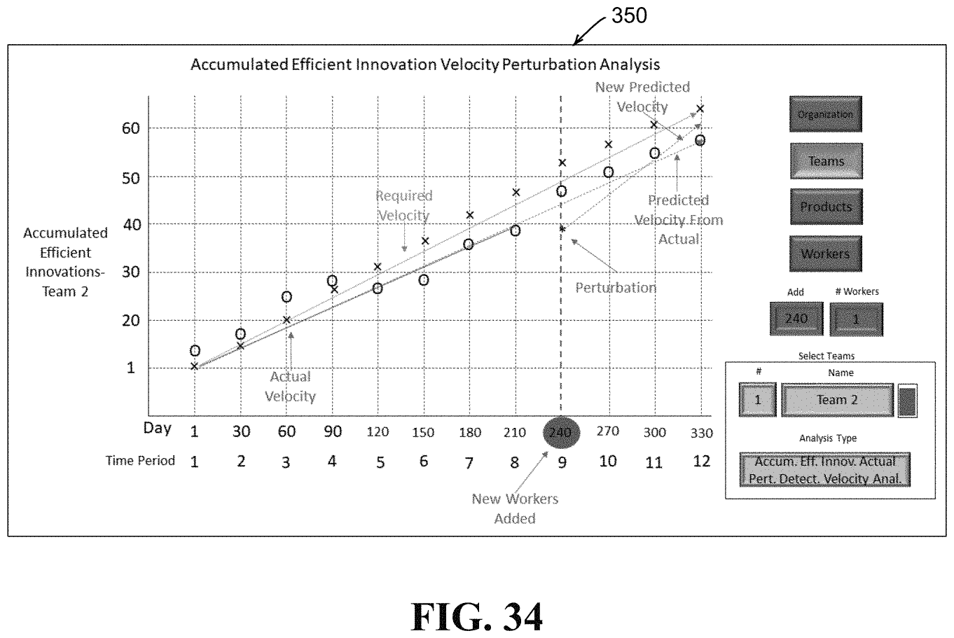

Based on actual average accumulated efficient innovation metric velocity of the team thus far in a project, the predicted team velocity to the end of the project based on the actual thus far, and the complexity-velocity profile of any proposed added new worker, an analysis is made to determine a potential new predicted team velocity, the overall impact on the team's performance and the schedule. If the predicted overall impact on the team's performance and the schedule is positive, then that addition is considered positive. FIG. 34 is an example 350 of existing team on existing project with predicted schedule perturbation characterization.

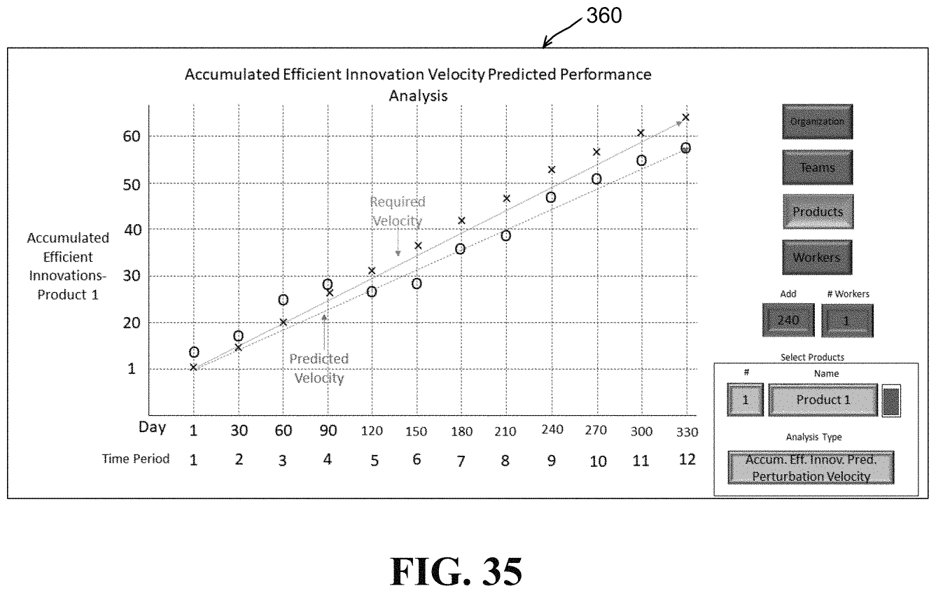

At the beginning of a new project, it is possible to predict the average accumulated efficient innovation metric velocity of the team based on the complexity-velocity profiles of the proposed team members and compare it to the required velocity for project completion. This allows the system to predict that a required schedule will be met or not. If not, the team can be composed of additional or different workers. FIG. 35 is an example 360 of predicted team performance analysis.

Automated Test Procedure Generation from Pathways

As shown in FIGS. 6-8, component pathways are composed of code blocks and control conditions. Control conditions allow code blocks within component pathways to be linked together without regard to the commonality of the output and input variables. That is, instead of the alignment between input and output variables being the determiner of linkage, linkage may be formed simply from the control conditions associated with the output variable attributes of the code blocks preceding the control conditions. This allows code blocks without matching inputs and outputs to link together component pathways.

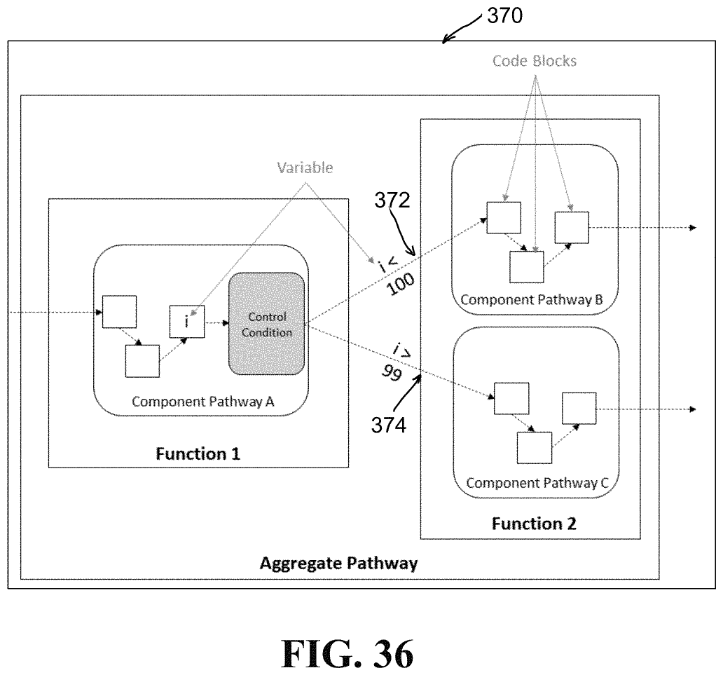

As shown in FIG. 14, the component pathways of one function can link to the component pathways of another function. FIG. 36 is an example 370 of component pathway connections using control conditions.

There are two aggregate pathways in FIG. 36: component pathway A to component pathway B 372, and component pathway A to component pathway C 374.

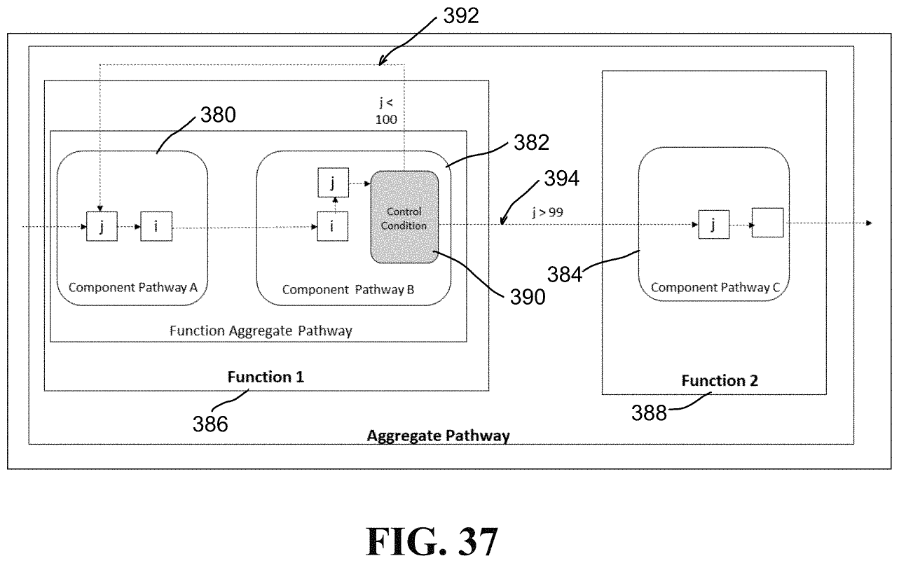

If the control condition leads to a previously activated code block, it represents a loop. FIG. 37 shows three component pathways 380, 382, 384 of two functions 386, 388 connected using a control condition 390 that forms a loop as part of component pathway B to create two aggregate pathways: component pathway A to component pathway B back to A 392, and component pathway A to component pathway B to component pathway C 394.

Linking component pathways via control conditions allows for the direct computation of cyclomatic complexity. Thus, analysis of aggregate pathways can correctly indicate the cyclomatic complexity for a group of linked functions. Analysis of the function aggregate pathway composed of the linked component pathways can correctly indicate the cyclomatic complexity of a function. This means that cyclomatic complexity can be calculated from design, not just from source code.

Since the linkage structure of any pathway can be completely defined, a set of procedures can be automatically generated, which can not only identify each pathway and the variables and their data values required to traverse a pathway, but also automatically find the data boundary conditions of each.

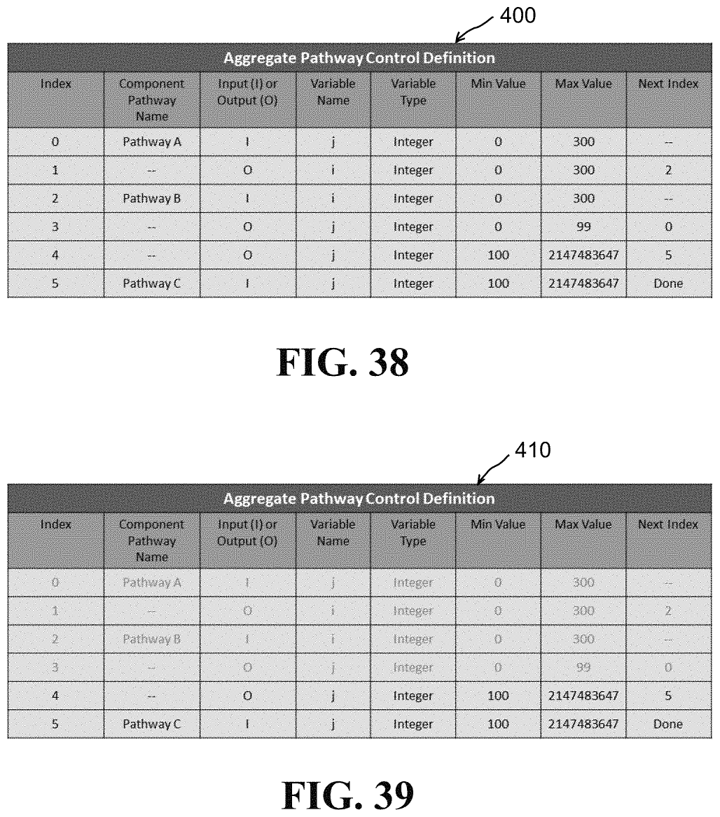

First, a table containing the input variables of each pathway and their required values is created and called the Aggregate Pathway Control Definition table. FIG. 38 provides Table 5—an example 400 of aggregate pathway control definition.

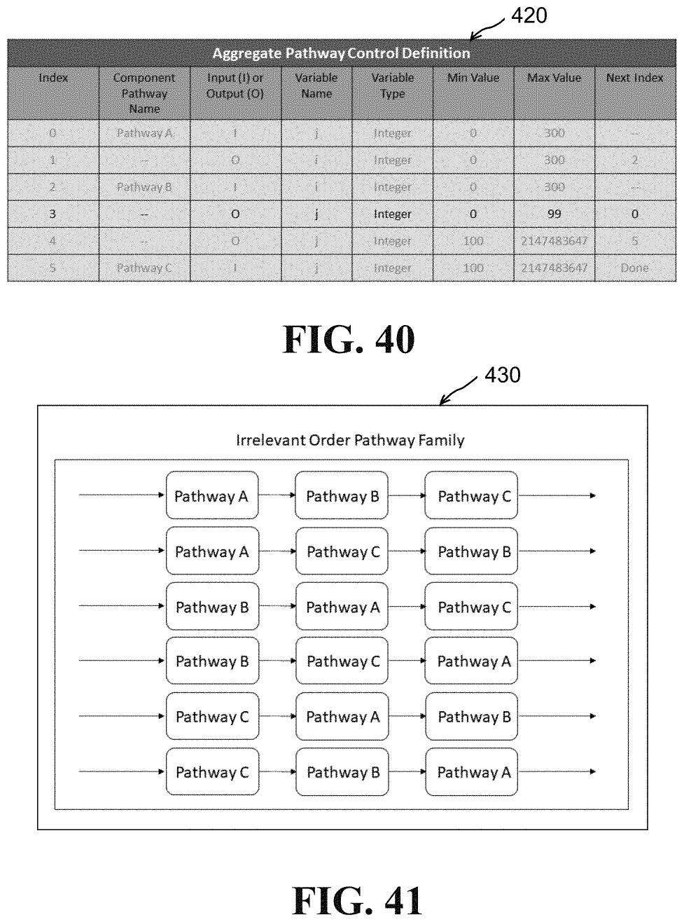

Table 5 of FIG. 38 shows the Aggregate Pathway Control Definition for FIG. 36. The system uses the data from the control conditions of component pathway B to create two aggregate pathways and determine the data boundary conditions used by each. The tables show the minimum and maximum values of the input variables to access one of the aggregate pathways, shown as lighter or green entries in the following tables: FIG. 39 provides Table 6—an example 410 showing first aggregate pathway. FIG. 40 provides Table 7—an example 420 showing second aggregate pathway.

To find the data boundary conditions given input variable values, a search is conducted starting with the lowest possible input value for the variable “i” of component pathway A. The smallest input value for variable “i” that creates the looping aggregate pathway becomes the minimum boundary condition value for that pathway. The maximum input value for variable “i” that creates the looping aggregate pathway becomes the maximum boundary condition value for that pathway. After the minimum and maximum values for every variable that leads to an aggregate pathway is found, a value between the minimum and maximum is determined to complete the boundary value analysis for each aggregate pathway.

The executable code associated with the source code of the aggregate pathways is run using the boundary values to generate all possible output variable values for those boundary values. Once verified as valid, these output variable values along with the associated input variable values for an aggregate pathway become the regression test procedures for the aggregate pathway.

The only human input required in this process is the identification of the functions to be tested and the verification that the initial test results are correct. The systems and methods 100 of the present invention ensures complete test coverage, then retains the comprehensive test procedures and automates the verification and validation when new functionality is added.

### Pathway Family Generation for Standard Form

Pathways can be categorized into various families. Being in a family allows any member of the family to be substituted for any other family member. Being able to substitute family members means that two pathways that ostensibly look different can be shown to actually be the same if, after substitution, the same data transformation takes place. A pathway can simultaneously belong to multiple families.

### Automatic Linked Order Irrelevant Pathway Family Generation

FIG. 41 is an example 430 of an irrelevant order component pathway family. There are some component pathways where the order in which they are linked does not matter. These component pathways are called order irrelevant component pathways. Since the order of these pathways does not matter, it is possible to automatically form a family of aggregate pathways that are equal by reordering the linked order irrelevant component pathways. One aggregate pathway can replace any other in the family.

### Automated Precision Management Using Pathway Families

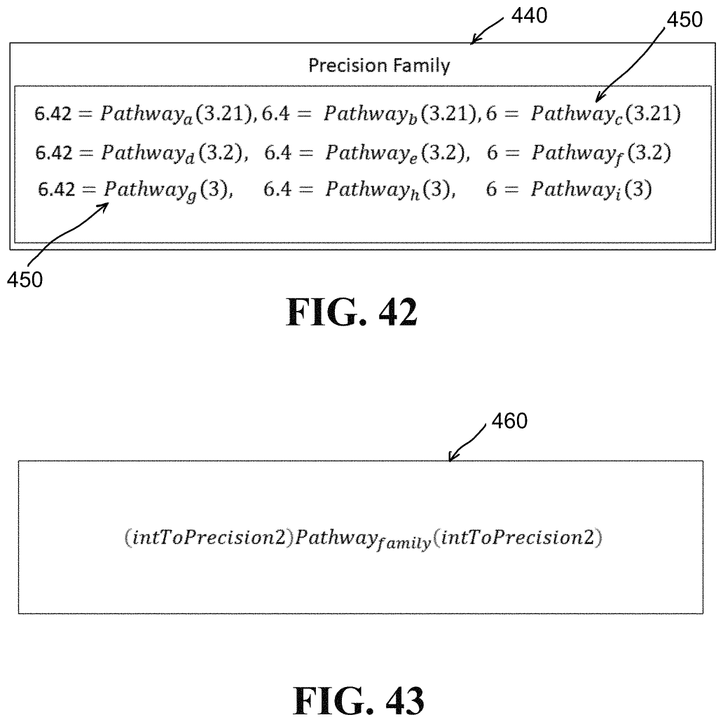

FIG. 42 is an example 440 of a family of pathways with different input and/or output precisions. Consider a set of component pathways a through i, each with both the same cyclomatic complexity and the same efficient innovation metric value. If they receive input variable values and generate output variable values that are the same except for the precision of the inputs and/or outputs, then these pathways taken together can be considered in the same family of pathways. One component pathway can replace any other in the family.

Interchanging component pathways of the same precision family does not change an innovation metric value, just the precision. One component pathway can replace any other in the family, but the precision must be changed by converting the initial precision to some required precision for the inputs and the outputs. Control conditions can also come in families, where the precision of the condition variables is used to define the family membership. The pathway family 450 shown in FIG. 42 might be represented as shown in FIG. 43, which is an example 460 of pathway family representation.

A duplicated algorithm can be detected, regardless of the precision used, by converting the source code into the component pathway form and comparing the various component pathways to their respective families.

Using component pathways with precision values that are higher than what is required induces processing time inefficiencies as the higher the precision of a calculation, the longer the processing time required. The precision required by component pathways in a chain of linked component pathways is equal to the lowest precision generated by all proceeding linked pathways. The performance of an algorithm can be optimized by replacing the precision of each component pathway in the link with the lowest precision detected as long as each component is a member of a precision family.

### Source Code Families

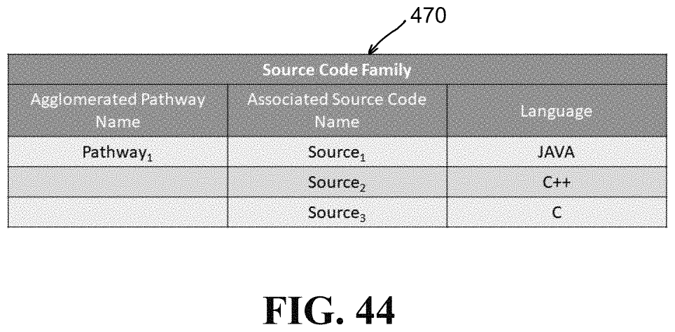

Since an aggregate pathway can have associated source code, but does not directly specify the source code, it is possible to have multiple source codes attached to that aggregate pathway. If multiple sources codes, each written with a different computer language, have been determined by boundary value analysis and precision management to represent the same software solution, then those source codes are in the same family. FIG. 44 provides Table 8—an example 470 of a source code family.

It is possible for a pathway to use any source code language in its source code family as its implementation. Thus, automatic language translation for known pathways into any known language can be accomplished. It is also possible to effectively mix computer languages, taking advantage of the advantages of each language for different parts of a software system.

### Automated Conversion to Standard Pathway Form

It is known that software solutions can be obscured in many ways: creating functions when grouping code is not required; creating functions in a more verbose than necessary form; changing the execution order of interchangeable code blocks; changing the precision of the functions as well as the function input/output variable types; changing the names of functions, subroutines or variables; adding additional functionality to a function; changing the source code language; embedding some or all functionality as firmware; and the conversion of functionality as Macros. There are even automated tools that aid in the obfuscation of code. This can make software intellectual property difficult to protect.

It is possible to convert source code into a design comprised of an MPT Hierarchical Functional Decomposition graph, and the systems and methods 100 of the present invention have shown that it is possible to convert an MPT Hierarchical Functional Decomposition graph into a set of pathways. This conversion into pathway form automatically removes source code language as a defining feature of a software solution. Removing all software solution obfuscation, whether accidental or intentional, using pathways is called conversion to standard pathway form, which requires the following steps:
1) All functions, firmware, and Macro code are replaced with family pathways,
2) Boundary value analysis is used to replace all component pathways with lower innovation versions,
3) All control conditions are replaced with family pathways,
4) All irrelevant order aggregate pathways are identified as such, and
5) Boundary value analysis is used to remove the internal control conditions from component pathways to form a single merged pathway. This is possible because the boundary value analysis already indicates the path to be taken for each component pathway, given some set of input variable values, eliminating the need for additional checks along the pathway.

After following the above steps, what is left is a set of aggregate pathways that ignore extraneous order, variable names, source code language, function or subroutine names or groupings, and precision. These aggregate pathways are also more efficient, thus meeting the criteria of the standard pathway form herein.

Two software solutions are equal if they both can be represented with the same set of aggregate pathways in the standard pathway form. Two software solutions are said to share functionality if they share some aggregate pathway that can be represented with the same aggregate pathway in the standard pathway form.

### Non-Software Markets

MPT Hierarchical Functional Decomposition graphs can be used to define the state transition diagrams used for finite state machines. This means that the systems and methods 100 of the present invention can be used in the following markets:
1) Software Design and Implementation,
2) Electrical Design and Implementation, and/or
3) Combined Software and Electrical

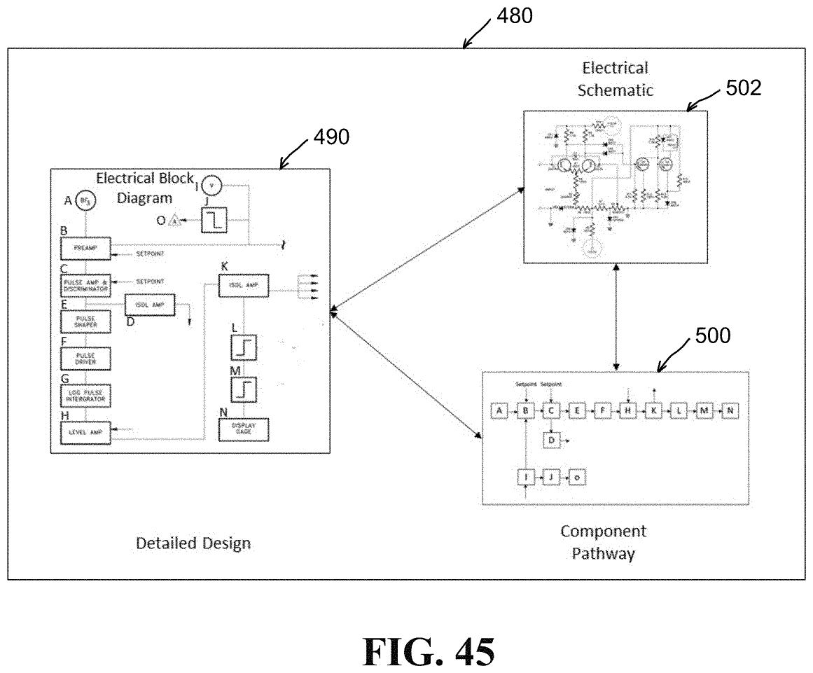

Pathways can represent source code or electrical components. FIG. 45 shows an example of an electrical system block diagram 480 at the detailed design level 490 translated into a component pathway 500. The electrical system design can be transformed into either electrical schematics 502 or component pathways 500 because electrical block diagrams can be considered detailed design for electrical systems.

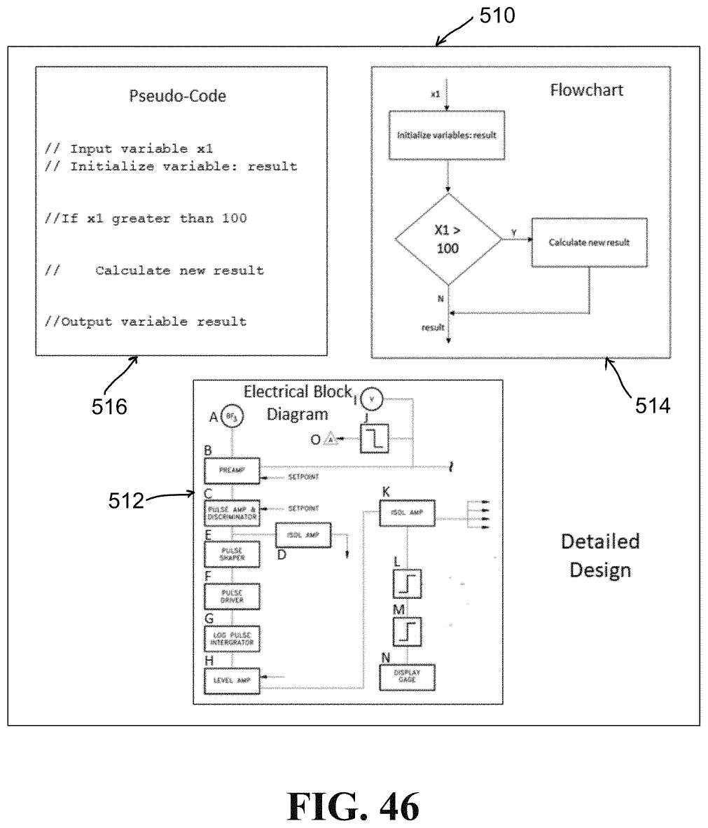

FIG. 46 shows an example 510 of detailed design elements for electrical and software conversion to component pathways. Electrical block diagrams 512 and flow charts 514 or pseudo code 516 occur at the detailed design level. This makes it possible for a single design to represent both the electrical and software aspects of a system.

As disclosed and detailed herein, there can be three primary embodiments for the present invention: Software Design and Implementation, Electrical Design and Implementation, and Combined Software and Electrical Design and Implementation.

Each embodiment can have analysis performed at the following levels: Organization level analysis, Team level analysis, Project level analysis, and Worker level analysis. Each analysis level can use the following pathways: Level one aggregate pathways, Aggregate pathways, Function aggregate pathways, and Component pathways.

Each of the following metrics can be applied at each analysis level: Innovation Metric, Efficient Innovation Metric, and Complete Innovation Metric. Each metric can be used in the following time analytics: Average Metric Speed Over Time, Average Metric Velocity Over Time, Average Metric Acceleration Over Time, Comparative Average Metric Speed Over Time, Comparative Average Metric Velocity Over Time, Comparative Average Metric Acceleration Over Time, Ranked Average Metric, Accumulated Metric Speed Over Time, Accumulated Metric Velocity Over Time, Accumulated Metric Acceleration Over Time, Comparative Accumulated Metric Speed Over Time, Comparative Accumulated Metric Velocity Over Time, Comparative Accumulated Metric Acceleration Over Time, and Ranked Accumulated Metric.

In addition, the following tools can be used at the worker level: Worker Complexity-Velocity Profile, Accumulated Innovation Prediction Given Worker Allocation, Accumulated Efficient Innovation Given Worker Allocation, Accumulated Complete Innovation Given Worker Allocation, Worker Hiring Preference Given Worker C-V Profile, Worker Training Time Prediction Given Worker C-V Profile, Worker Performance Progress Over Time Given Innovation Metrics, Worker Performance Progress Over Time Given Efficient Innovation Metrics, Worker Performance Progress Over Time Given Complete Innovation Metrics, Team Average Perturbation Given New Workers, Gantt Chart Schedule Prediction Given Innovation Vectors, Gantt Chart Schedule Prediction Efficient Innovation Vectors, and Gantt Chart Schedule Prediction Given Complete Innovation Vectors.

Pathways can also be identified and sorted into the following families: Order Irrelevant Families, Precision Families, and Source Code Families.

While various embodiments have been described above, it should be understood that they have been presented by way of example only, and not limitation. Thus, the breadth and scope of the present disclosure should not be limited by any on the above-described embodiments or examples. Moreover, any combination of the above-described elements in all possible variations thereof is encompassed by the disclosure unless otherwise indicated herein or otherwise clearly contradicted by context.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order and are not meant to be limited to the specific order or hierarchy presented.

While the present invention has been described in connection with various aspects and examples, it will be understood that the present invention is capable of further modifications. This application is intended to cover any variations, uses or adaptation of the invention following, in general, the principles of the invention, and including such departures from the present disclosure as come within the known and customary practice within the art to which the invention pertains.

It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products.

For purposes of interpreting the claims for the present invention, it is expressly intended that the provisions of 35 U.S.C. § 112(f) are not to be invoked unless the specific terms “means for” or “step for” are recited in a claim.

What is claimed is:

1. A software method of automatic innovation determination, comprising:
decomposing a software source code into one or more hierarchical functions;
decomposing the one or more hierarchical functions into one or more linked pathways corresponding to a Hierarchical Functional Decomposition (HFD) graph;
decomposing the HFD graph into one or more linked component pathways;
calculating a probability of existence for the one or more linked component pathways; and
calculating an innovation metric for the one or more linked component pathways.

2. The method of claim 1, further comprising graphing innovation results of multiple of the one or more linked component pathways.

3. The method of claim 1, wherein the one or more linked component pathways comprise one or more Level One Aggregate Pathways (LOAPs).

4. The method of claim 1, wherein the one or more linked components pathways comprise one or more Functional Aggregate Pathways (FAPs).

5. The method of claim 1, wherein calculating an innovation metric comprises calculating a number of permutations possible for a specific number of the one or more linked component pathways selected at a time during a specific period of time.

6. The method of claim 1, wherein when the calculated probability of existence decreases, an innovation determination increases.

7. The method of claim 1, wherein the one or more hierarchical functions comprise one or more hierarchical function trees.

8. The method of claim 1, further comprising converting one or more of the one or more hierarchical functions into one or more pseudo codes or one or more flow charts.

9. The method of claim 8, wherein the one or more pseudo codes or the one or more flow charts are transformed into source code.

10. The method of claim 1, further comprising calculating a complexity of efficient innovation determination.

11. An automatic innovation determination software system, comprising:
a memory; and
a processor operatively coupled to the memory, wherein the processor is configured to execute program code to:
decompose a software source code into one or more hierarchical functions;
decompose the one or more hierarchical functions into one or more linked pathways corresponding to a Hierarchical Functional Decomposition (HFD) graph;
decompose the HFD graph into one or more linked component pathways;
calculate a probability of existence for the one or more linked component pathways; and
calculate an innovation metric for the one or more linked component pathways.

12. The system of claim 11, wherein the processor is further configured to execute program code to graph innovation results of multiple of the one or more linked component pathways.

13. The system of claim 11, wherein the one or more linked component pathways comprise one or more Level One Aggregate Pathways (LOAPs).

14. The system of claim 11, wherein the one or more linked components pathways comprise one or more Functional Aggregate Pathways (FAPs).

15. The system of claim 11, wherein calculating an innovation metric comprises calculating a number of permutations possible for a specific number of the one or more linked component pathways selected at a time during a specific period of time.

16. The system of claim 11, wherein when the calculated probability of existence decreases, an innovation determination increases.

17. The system of claim 11, wherein the one or more hierarchical functions comprise one or more hierarchical function trees.

18. The system of claim 11, wherein the processor is further configured to execute program code to convert one or more of the one or more hierarchical functions into one or more pseudo codes or one or more flow charts.

19. The system of claim 18, wherein the one or more pseudo codes or the one or more flow charts are transformed into source code.

20. The system of claim 11, wherein the processor is further configured to execute program code to calculate a complexity of efficient innovation determination.
